(19) United States
(12) Patent Application Publication
(10) Pub. No.: US 2016/0148232 A1
(43) Pub. Date: May 26, 2016

(54) USING HASHED MEDIA IDENTIFIERS TO DETERMINE AUDIENCE MEASUREMENT DATA INCLUDING DEMOGRAPHIC DATA FROM THIRD PARTY PROVIDERS

(71) Applicant: The Nielsen Company (US), LLC, Schaumburg, IL (US)

(72) Inventor: Jan Besehanic, Tampa, FL (US)

(21) Appl. No.: 14/550,504

(22) Filed: Nov. 21, 2014

(51) Int. Cl. G06Q 30/02

(52) U.S. Cl. CPC G06Q 30/0204

(57) ABSTRACT

Example methods to perform audience measurement disclosed herein include performing a hashing operation on a first media identifier and a plurality of data values to determine a plurality of hashed media identifiers to identify first media, a first one of the hashed media identifiers being different from a second one of the hashed media identifiers. Disclosed example methods also include sending the first one of the hashed media identifiers to a media provider to identify the first media during a first monitoring interval. Disclosed example methods further include determining audience measurement data associated with the first media and the first monitoring interval based on reporting data received from a service provider different from the media provider, the reporting data including the first one of the hashed media identifiers and demographic data corresponding to a subscriber associated with a media device that received the first media from the media provider.

### FIELD OF THE DISCLOSURE

This disclosure relates generally to audience measurement and, more particularly, to using hashed media identifiers to determine audience measurement data including demographic data from third party providers.

### BACKGROUND

Many audience measurement systems embed media identifiers (e.g., program identifiers, source identifiers, creator identifiers, etc.) in media and/or include the media identifiers in metadata accompanying the media to enable identification of the media when it is accessed and/or presented by a media device. However, the media identifiers used in prior audience measurement systems are often represented in plaintext. As such, the media identifiers embedded in or otherwise accompanying the media can be read by entities other than the audience measurement entities (or other authorized users) utilizing the audience measurement systems.

### BRIEF DESCRIPTION OF THE DRAWINGS

FIG. 1 is a block diagram of an example environment of use including an example audience measurement system that uses hashed media identifiers to determine audience measurement data including demographic data from third party providers in accordance with the teachings of this disclosure.

FIG. 2 illustrates example operations involving hashed media identifiers that may be performed by the example audience measurement system of FIG. 1 to determine audience measurement data including demographic data from third party providers in accordance with the teachings of this disclosure.

FIG. 3 is a block diagram of an example audience measurement entity server that may be used to implement the example audience measurement system of FIG. 1.

FIG. 4 is a block of an example media provider server that may be used to implement the example audience measurement system of FIG. 1.

FIG. 5 is a block of an example media device that may be used to implement the example audience measurement system of FIG. 1.

FIG. 6 is a block of an example service provider server that may be used to implement the example audience measurement system of FIG. 1.

FIG. 7 is a flowchart representative of example process that uses hashed media identifiers to determine audience measurement data including demographic data from third party providers in the example audience measurement system of FIG. 1.

FIGS. 8A-8B are flowcharts representative of example machine readable instructions that may be executed to implement the audience measurement entity server of FIGS. 1 and/or 3.

FIG. 9 is a flowchart representative of example machine readable instructions that may be executed to implement the example media provider server of FIGS. 1 and/or 4.

FIG. 10 is a flowchart representative of example machine readable instructions that may be executed to implement the example media device(s) of FIGS. 1 and/or 5.

FIG. 11 is a flowchart representative of example machine readable instructions that may be executed to implement the example service provider server of FIGS. 1 and/or 6.

FIG. 12 is a block diagram of an example processor platform structured to execute the example machine readable instructions of FIGS. 8A-8B to implement the example audience measurement entity server of FIGS. 1 and/or 3.

FIG. 13 is a block diagram of an example processor platform structured to execute the example machine readable instructions of FIG. 9 to implement the example media provider server of FIGS. 1 and/or 4.

FIG. 14 is a block diagram of an example processor platform structured to execute the example machine readable instructions of FIG. 10 to implement the example media device(s) of FIGS. 1 and/or 5.

FIG. 15 is a block diagram of an example processor platform structured to execute the example machine readable instructions of FIG. 11 to implement the example service provider server of FIGS. 1 and/or 6.

Wherever possible, the same reference numbers will be used throughout the drawing(s) and accompanying written description to refer to the same or like parts, elements, etc.

### DETAILED DESCRIPTION

Methods, apparatus, systems and articles of manufacture (e.g., physical storage media) that use hashed media identifiers to determine audience measurement data including demographic data from third party providers are disclosed herein. Some such example methods (e.g., performed at an audience measurement entity) to perform audience measurement disclosed herein include performing a hashing operation on a first media identifier and a plurality of data values to determine a plurality of hashed media identifiers to identify first media. In some such examples, a first one of the hashed media identifiers is different from a second one of the hashed media identifiers. Some such example methods also include sending the first one of the hashed media identifiers to a media provider to identify the first media during a first monitoring interval. Some such example methods further include determining first audience measurement data associated with the first media and the first monitoring interval based on first reporting data received from a service provider different from the media provider. In some such examples, the first reporting data includes the first one of the hashed media identifiers and demographic data corresponding to a subscriber associated with a media device that received the first media from the media provider.

In some such example methods, respective ones of the hashed media identifiers are associated with respective different monitoring intervals. Some such example methods also include sending the respective ones of the hashed media identifiers to the media provider to identify the first media during the respective different monitoring intervals. In some such example methods, performing the hashing operation includes performing the hashing operation on the first media identifier and a first one of the data values to determine the first one of the hashed media identifiers associated with the first monitoring interval. In some such example methods, performing the hashing operation also includes performing the hashing operation on the first media identifier and a second one of the data values to determine a second one of the hashed media identifiers associated with a second monitoring interval. Additionally or alternatively, in some such example methods, the plurality of data values includes respective temporal values associated with respective ones of the different monitoring intervals.

In some such example methods, the media provider is to provide the first one of the hashed media identifiers to the media device when providing the first media to the media device during the first monitoring interval.

Some such example methods include generating the plurality of data values with at least one of random number generator or a pseudorandom number generator.

In some such example methods, determining the first audience measurement includes accessing a first server using the first one of the hashed media identifiers to determine first descriptive data associated with the first media. For example, the first server may cross-reference the first one of the hashed media identifiers with at least one of the first descriptive data or the first media identifier. Some such example methods also include combining the first descriptive data with the demographic data to determine the first audience measurement data. Additionally, in some such examples, the first reporting data further includes timestamp data indicating when the media device at least one of accessed the first media from the media provider or presented the first media after accessing the first media from the media provider. In some such example methods, determining the first audience measurement data further includes combining the first descriptive data with the demographic data and the timestamp data to determine the first audience measurement data. Additionally or alternatively, in some such example methods, the first server cross-references pluralities of the hashed media identifiers identifying a plurality of different media with a plurality of descriptive data associated with the plurality of different media. For example, respective pluralities of the hashed media identifiers may identify respective ones of the different media.

In some such example methods, using the first one of the hashed media identifiers to determine the audience measurement data associated with the first media preserves privacy of a user of the media device by permitting the service provider to relay the first one of the hashed media identifiers from the media device to an audience measurement entity without the service provider being able to identify the first media.

Some example methods (e.g., performed at a media provider) to perform audience measurement disclosed herein include providing a first hashed media identifier of first media to a media device when providing the first media to the media device during a first monitoring interval to perform audience measurement associated with the first media. Some such examples also include providing a second hashed media identifier of the first media different from the first hashed media identifier to the media device when providing the first media to the media device during a second monitoring interval to perform audience measurement associated with the first media. In some such examples, the first hashed media identifier and/or the second hashed media identifier are received from an audience measurement entity.

In some such example methods, providing the first hashed media identifier to the media device involves including the first hashed media identifier in a data field of a data stream conveying the first media to the media device. Additionally or alternatively, in some such example methods, providing the first hashed media identifier to the media device involves embedding the first hashed media identifier as a watermark in the first media.

Some such example methods further include receiving the first hashed media identifier from the audience measurement entity before the first monitoring interval. Some such example methods also include receiving the second hashed media identifier from the audience measurement entity after receiving the first hashed media identifier and before the second monitoring interval.

In some such example methods, using the first one of the hashed media identifiers to perform audience measurement data associated with the first media preserves privacy of a user of the media device by permitting a service provider to relay the first one of the hashed media identifiers from the media device to the audience measurement entity without the service provider being able to identify the first media.

Some example methods (e.g., performed at a media device) to perform audience measurement disclosed herein include accessing a first hashed media identifier accompanying first media provided by a media provider to the media device. Some such example methods also include reporting the first hashed media identifier and a device identifier identifying the media device to a service provider different from the media provider to monitor at least one of accessing or presenting the first media at the media device.

In some such example methods, accessing the first hashed media identifier includes detecting a watermark embedded in the first media. In some such examples, accessing the first hashed media identifier also includes decoding the first hashed media identifier from the watermark.

In some such example methods, accessing the first hashed media identifier comprises retrieving the first hashed media identifier from a data field of a data stream conveying the first media from the media provider to the media device.

In some such example methods, the device identifier includes at least one of a cookie stored on the media device, a network address of the media device or an Internet mobile station identity (IMEI) of the media device.

Some such example methods further include reporting timestamp data with the first hashed media identifier and the device identifier. For example, the timestamp data may indicate when the first media was at least one of accessed or presented by the media device.

In some such example methods, wherein using the first one of the hashed media identifiers to monitor the at least one of accessing or presenting the first media at the media device preserves privacy of a user of the media device by permitting a service provider to relay the first one of the hashed media identifiers from the media device to the audience measurement entity without the service provider being able to identify the first media.

Some example methods (e.g., performed at a service provider other than a media provider) to perform audience measurement disclosed herein include accessing first reporting data including a device identifier and a first hashed media identifier received from a media device. For example, the device identifier may identify the media device, and the first hashed media identifier may have been determined from a first media identifier associated with first media accessed by the media device from a media provider. Some such example methods also include determining first demographic data for a first subscriber of a service provider different from the media provider. For example, the first subscriber may be associated with the media device identified by the device identifier. Some such example methods further include reporting second reporting data including the first hashed media identifier and the first demographic data to an audience measurement entity to perform audience measurement associated with the first media.

In some such example methods, the first reporting data further includes timestamp data indicating when the first media was at least one of accessed or presented by the media device. Some such example methods further involve including the timestamp data in the second reporting data reported to the audience measurement entity.

In some such example methods, determining the first demographic data involves retrieving the first demographic data from a server using the device identifier. In some such examples, the server stores a plurality of demographic data associated with a plurality of subscribers of the service provider, and the server associates respective demographic data with respective ones of the plurality of subscribers using device identifiers of media devices associated with the plurality of subscribers.

In some such example methods, the device identifier includes at least one of a cookie stored on the media device, a network address of the media device or an Internet mobile station identity (IMEI) of the media device.

In some such example methods, using the first hashed media identifier to perform audience measurement data associated with the first media preserves privacy of a user of the media device by permitting the service provider to relay the first hashed media identifier from the media device to the audience measurement entity without the service provider being able to identify the first media.

In some such example methods, the audience measurement entity does not distribute the first media to the media device. In some such example methods, the first media is not provided by the service provider.

These and other example methods, apparatus, systems and articles of manufacture (e.g., physical storage media) that use hashed media identifiers to determine audience measurement data including demographic data from third party providers are disclosed in further detail below.

As mentioned above, many audience measurement systems rely on media identifiers (e.g., program identifiers, source identifiers, creator identifiers, etc.) embedded in and/or otherwise accompanying media to identify the media when it is accessed and/or presented by a monitored media device. Such audience measurement systems use the detected media identifiers, as well as timestamp data indicating when the media identified by the media identifiers was accessed and/or presented by the monitoring media devices, to determine audience measurement data characterizing, for example, the size (e.g., over time) of the audience of the media. Some audience measurement systems also incorporate demographics data into their audience measurement data to further characterize, for example, the composition of the audience of the media. To obtain the demographic data, some such prior audience measurement systems rely on panels of device users, who agree in advance to provide demographic data and have their device usage monitored by an audience measurement entity. Typically, such panels are limited in size and, as such, may not accurately represent the audience of the media being monitored in some circumstances. Accordingly, some prior audience measurement systems also request demographic information from third-party service providers (e.g., such as social media providers, gaming service providers, email service providers, etc.) having subscribers that are associated with (e.g., owners or registered users of) the monitored media devices.

However, as noted above, the media identifiers used in prior audience measurement systems are usually represented in plaintext. Thus, to preserve the privacy of audience members (e.g., the media device users), and to keep valuable currency in the form of detected media identification information from becoming known to unauthorized entities, prior audience measurement systems typically do not provide the detected media identifiers to other entities. Instead, prior audience measurement entity servers are architected to receive media monitoring data from the monitored media devices (or meters monitoring the media devices) and to receive separate demographic data from the third-party service reports. Such architectures require these prior audience measurement entity servers to support data reporting interfaces with two different types of reporting sources (e.g., the monitored media devices and/or associated device meters vs. the third party service providers), and to expend resources to merge the different data reported from these different sources.

Disclosed example audience measurement systems that use hashed media identifiers to determine audience measurement data including demographic data from third party providers provide technical solutions to the technical problem of obtaining both media identification data monitored by media device meters and demographic data from third-party service providers while preserving the privacy of audience members and without requiring multiple reporting interfaces for different types of data reporting sources. Disclosed example audience measurement systems achieve these technical solutions by determining hashed media identifiers, which are encrypted or otherwise obfuscated versions of the plaintext media identifiers identifying the media being monitored. For example, the hashed media identifiers may be determined by processing the plaintext media identifiers (and possibly other data, as described in further detail below) with a one-way hash function. The disclosed example audience measurement systems provide the hashed media identifiers to media providers, which embed the hashed media identifiers in the media to be monitored, or otherwise cause the hashed media identifiers to accompany the media.

Because the media identifiers provided with the monitored media are hashed, their meaning is obfuscated. For example, an unauthorized entity is prevented from reconstructing an original, plaintext media identifier from a hashed media identifier due to the one-way nature of the hashing operation. In some examples, for the same media, the audience measurement entity determines different hashed media identifiers for use during different monitoring intervals to make reconstructing an original, plaintext media identifier from the hashed media identifiers even more difficult for an unauthorized entity. To permit the audience measurement entity and/or other authorized entities to use the hashed media identifiers to identify monitored media in the disclosed example audience measurement systems, the audience measurement entity employs a hash table or other mapping mechanism to cross-reference the hashed media identifiers with the corresponding plaintext media identifiers. Thus, when hashed media identifiers are detected in the monitored media and reported to the audience measurement entity (or other authorized entity), the identity of the monitored media can be ascertained using the hash table to map the reported hashed media identifiers to the corresponding plaintext media identifiers.

Furthermore, because the hashed media identifiers obfuscate (e.g., hide) the identity of the monitored media, in some disclosed examples the audience measurement system is architected to provide the detected hashed media identifiers (and other data, as described in further detail below) from the monitored media devices (and/or device meters) to the third-party service provider(s) with demographic data requests. In such examples, the third-party service provider(s) can relay the hashed media identifiers (and other data) to the audience measurement entity with the requested demographic data, but the third-party service provider(s) cannot learn the actual identify of the media corresponding to the hashed media identifiers due to the one-way nature of the hashed media identifiers. Accordingly, in such architectures, the audience measurement entity need not support multiple reporting interfaces to receive reporting data from the monitored media devices (and/or the device meters monitoring the media device) and separate reporting data from the third-party service provider(s). Instead, in such disclosed architectures, it is sufficient for the audience measurement entity to receive reporting from just the third-party service provider(s), as such data will include the demographic data and the passed-through hashed media identifiers and other data provided by the monitored media devices (and/or device meters) to the third-party service provider(s) with the demographic data requests. In this way, example audience measurement systems that use hashed media identifiers to determine audience measurement data including demographic data from third party providers disclosed herein can have reduced technical complexity relative to prior systems (e.g., due to the need to support fewer data reporting interfaces) while preserving the privacy of audience members (e.g., by obfuscating the media identifiers that propagate in the system).

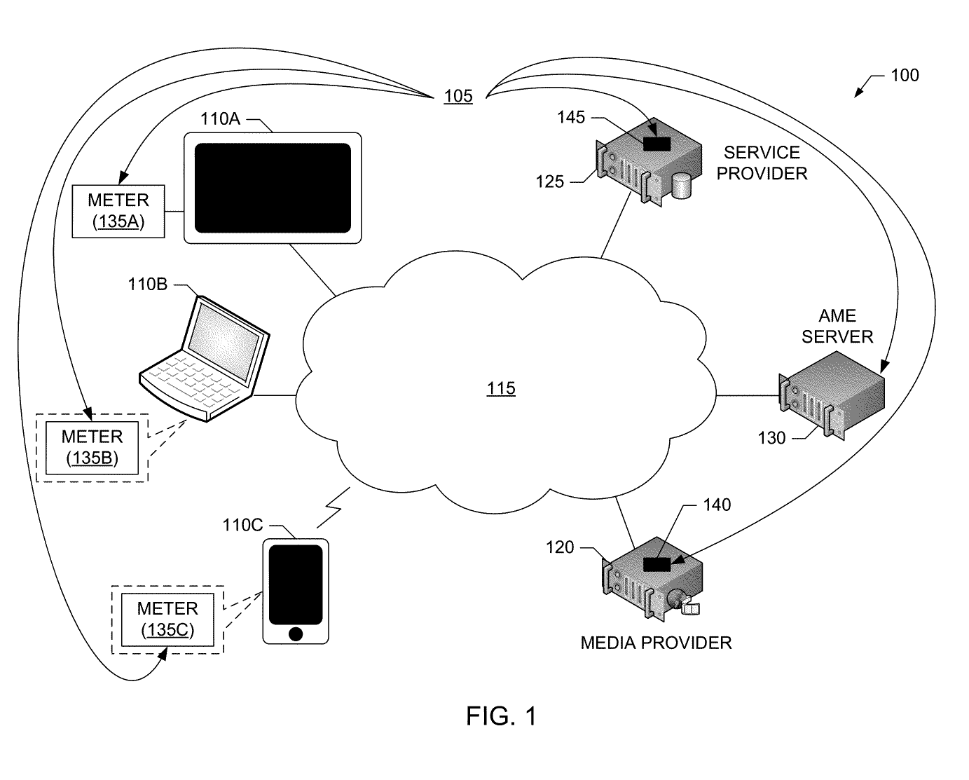

Turning to the figures, a block diagram of an example environment of use 100 for an example audience measurement system 105 that uses hashed media identifiers to determine audience measurement data including demographic data from third party providers as disclosed herein is illustrated in FIG. 1. The example audience measurement system 105 of FIG. 1 generates audience measurement data characterizing audiences exposed to different online media via one or more media devices, such as the examples media devices 110A-C. In the example environment of use 100, the example media devices 110A-C are in communication with an example network 115 and, as such, are able to access online media from one or more media servers, such as an example media provider server 120. For example, the media devices 110A-C are able to access the media provider server 120 and/or other servers (e.g., an ad server, etc.) via the network 115, and receive and present media, such as movies, television programs, advertisements, etc., streamed and/or otherwise obtained from the media provider server 120 and/or other servers. In some such examples, the audience measurement data generated by the audience measurement system 110 characterizes (potentially in real-time) the sizes of audiences, compositions of audiences, etc., of different media accessed from servers, such as the media provider server 120, and/or presented by the media device(s) 115A-C, as well as how such audiences vary over time.

In the example environment of use 100, one or more of the media device(s) 115A-C are used by subscribers to access services provided by one or more service providers different from media provider(s) providing media via the media provider server(s) 120. For example, such service providers can correspond to, for example, one or more social media providers (e.g., such as Facebook, Twitter, etc.), one or more email service providers (e.g., such as Google, Hotmail, Yahoo!, etc.), one or more credit bureaus (e.g., such as Experian, etc.), etc. As such, the example environment of use 100 of FIG. 1 includes one or more service provider servers, such as the example service provider server 125, operated by the service provider(s) to manage their respective subscribers. For example, the service provider server 125 is in communication with the example network 115 and maintains demographic information, such as name information, address information, billing information and/or any other demographic data, provided by the subscribers of the associated service provider when the subscribers sign-up for service. Any service provider or other entity having a network-accessible database identifying demographics of a set of individuals (e.g., subscribers) may cooperate with an audience measurement entity and implement functionality associated with the service provider server 125 of the illustrated example. Such entities may be referred to as “database proprietors” and include the service providers mentioned above (e.g., Facebook, Google, Yahoo!, Twitter, Hotmail, Experian, etc.).

As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In the illustrated example of FIG. 1, respective ones of the example media devices 110A-C of FIG. 1 can be implemented by any computing device, apparatus, system, etc., such as a mobile phone or smartphone, a tablet computer (e.g., an Apple iPad™), a notebook computer, a desktop computer, a gaming device (e.g., a Nintendo 3DS™), a gaming console (e.g., a Microsoft Xbox 360™, a Playstation PS4™, a Nintendo Wii U™, etc.), a personal digital assistant (PDA), etc. The example network 115 of FIG. 1 can be implemented by any type(s), number(s) and/or combination of computing networks, such as a mobile cellular network, a wireless local area network (WLAN), such as a WiFi network, a proprietary wireless network, the Internet, etc. The example media provider server 120 of FIG. 1 can be implemented by a streaming media service, such as Netflix, Hulu, Amazon, etc., accessible from the media devices 110A-C, an advertisement server, a news portal hosting media, a web portal hosting media, etc. As such, the media provider server 120 can be implemented by any type(s), number and/or combination of physical and/or virtual servers and/or platforms capable of streaming media over a network to a media device, such as the media devices 110A-C. The service provider server(s) 125 can be implemented by any type(s), number(s) and/or combination of physical and/or virtual servers and/or platforms capable of providing the service(s) offered by their associated service providers.

To generate audience measurement data using hashed media identifiers as disclosed herein, the audience measurement system 105 of the illustrated example includes an example audience measurement entity (AME) server 130 operated by an AME, example device meters 135A-C to monitor the respective media devices 110A-C, example media server metering functionality 140 implemented by the example media provider server(s) 120, and example service provider functionality 145 implemented by the example service provider server(s) 125. In the illustrated example of FIG. 1, the media to be monitored by the audience measurement system 105 is provided by media provider(s), such as the media provider(s) operating the media provider server(s) 120. In the illustrated example of FIG. 1, the audience measurement system 105 does not monitor media provided, if at all, from service providers, such as the service provider(s) operating the service provider server(s) 125. In the illustrated example of FIG. 1, the AME is an entity separate from the media provider(s) and the service provider(s), and does not distribute media to media device(s) being monitored by the audience measurement system 105 but, instead, is a neutral (trusted) third party responsible for providing audience measurement data characterizing audience exposure to media provided by the media provider(s) to the monitored media device(s).

In the illustrated example of FIG. 1, the AME server 130 can be implemented by any type(s), number(s) and/or combination of physical and/or virtual servers and/or platforms. In the illustrated example of FIG. 1, the meters 135A-C can be implemented by any type(s), number(s) and/or combination of application(s) (e.g., apps) executing on the media devices 110-C, and/or monitoring devices electrically coupled to (e.g., via an electrical data port), optically coupled to (e.g., via an electrical optical port) and/or otherwise in communication with the media devices 110A-C, and capable of determining monitoring data, such as the monitoring data described above, characterizing exposure to online media at the media devices 110A-C. In some examples, the media provider associated with the media provider server 120 and/or the service provider associated with the service provider server 125 causes the meter(s) 135A-C to be downloaded to one or more of the media devices 110A-C as a condition to access streaming media offered by the media provider, and/or a service offered by the service provider. Such meters may be referred as non-panelist meters to distinguish them from panelist meters that are provided to panelists statistically selected by the AME for inclusion in an audience measurement panel (and which panelist meters may include more extensive media monitoring functionality than the non-panelist meters). However, in some examples, one or more of the meters 135A-C may correspond to a panelist meter provided by an AME. As such, the online media monitoring solutions disclosed herein can be used to monitor a media device regardless of whether the media device is associated with an AME panelist (e.g., via a non-panelist meter for non-panelists and/or a panelist meter for panelists).

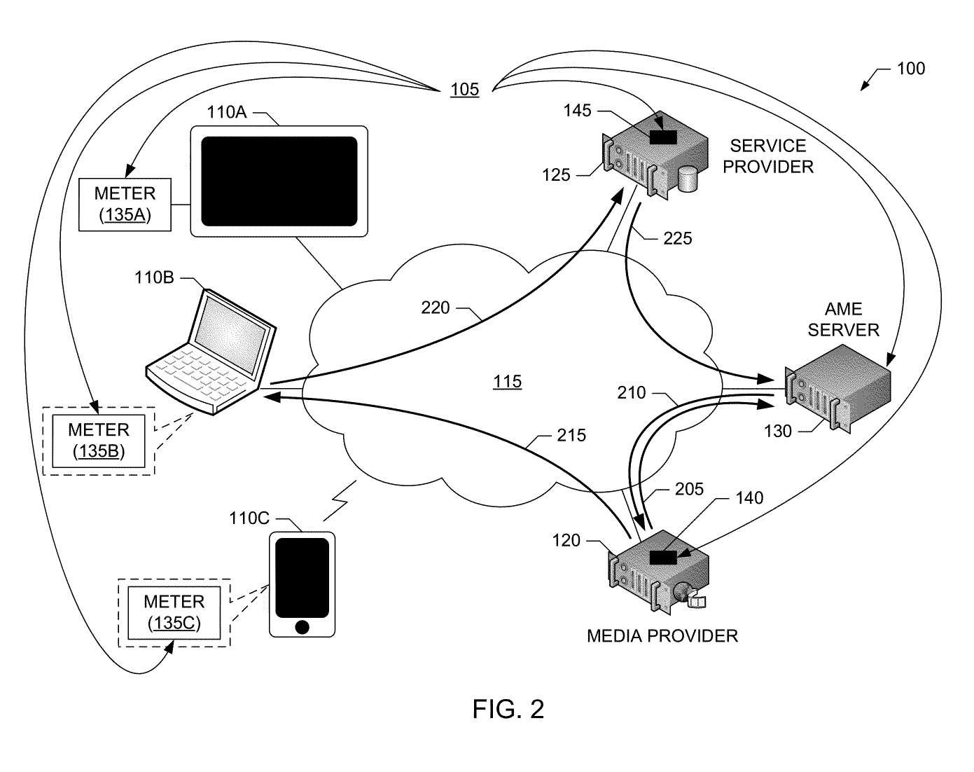

Example operations performed by the AME server 130, the device meters 135A-C, the media server metering functionality 140 implemented by the media provider server 120 and the service provider functionality 145 implemented by the service provider server 125 to generate audience measurement data using hashed media identifiers are illustrated in FIG. 2. In the illustrated example of FIG. 2, in a first example operation 205 (represented by a directed line 205 in FIG. 2), the AME server 130 receives descriptive data from the media provider server 120, which describes the media to be monitored by the audience measurement system 105. For example, the descriptive data may include media identifiers (e.g., program identifiers, source identifiers, creator identifiers, etc.) identifying the media to be monitored, and/or other descriptive data (e.g., electronic program guide data, etc.) from which media identifiers may be generated. In the illustrated example, the media identifiers received in and/or generated from the descriptive data provided to the AME server 130 by the media provider server 120 in operation 205 are in plaintext form or, in other words, are decodable by an unauthorized user.

In a second example operation 210 (represented by a directed line 210 in FIG. 2), the AME server 130 generates one or more hashed media identifiers for respective ones of the plaintext media identifiers received in and/or generated from the descriptive data received in operation 205, and provides the hashed media identifiers to the media provider server 120 to identify the media accessed and/or presented in the example environment of use 100. As disclosed in further detail below, the hashed media identifier(s) for a respective plaintext media identifier is(are) generated by processing the plaintext media identifier (possibly combined with other data) with a one-way hashing operation. As the hashing operation is one-way, a reverse hashing operation to directly generate the original plaintext media identifier from the hashed media identifier does not exist. Accordingly, the hashed media identifier(s) cannot be used (at least directly) to recover the original plaintext media identifier absent further information (e.g., such as a hash table, as described in further detail below).

In some examples, example operations 205 and 210 are replaced with operations in which the media provider server 120 generates the one or more hashed media identifiers for the respective ones of the plaintext media identifiers, and provides the hashed media identifier(s) to the AME server 130. In such examples, the media provider server 120 also generates the hash table mapping each respective plaintext media identifier to its corresponding one or more hashed media identifiers, and provides the hash table to the AME server 130.

In a third example operation 215 (represented by a directed line 215 in FIG. 2), the example media server metering functionality 140 implemented by the media provider server 120 causes hashed media identifier(s) to be embedded in and/or to otherwise accompany media provided to the media devices 110A-B. For convenience, and without loss of generality, in the illustrated example of FIG. 2, the example operation 215 provides the hashed media identifier(s) with the associated media provided to the media device 110B as shown.

In a fourth example operation 220 (represented by a directed line 220 in FIG. 2), the device meter 135B implemented by or otherwise associated with the media device 110B determines media monitoring data characterizing media exposure associated with the media device 110B, and reports the determined media monitoring data to the example service provider server 125. In some examples, the media monitoring data determined by the device meter 135B and reported to the service provider server 125 includes the hashed media identifiers identifying the media accessed and/or presented by the media device 110B, and a device identifier identifying the media device 110B. In some examples, the online media monitoring data also includes timestamp data containing timestamps associated with the reported hashed media identifiers and indicating when the media identified by the hashed media identifiers was accessed, presented, etc. Because the hashed media identifiers included in the media monitoring data reported by the device meter 135B are hashed, the service provider server 125 is unable to identify the particular media accessed and/or presented by the media device 110B.

The media monitoring data also expressly includes a request for the service provider to provide demographic associated with the device identifier, or implicitly causes the service provider to determine the demographic data in response to receiving the media monitoring data including the device identifier. Accordingly, in a fifth example operation 225 (represented by a directed line 225 in FIG. 2), the service provider functionality 145 implemented by the service provider server 125 uses the device identifier included in the media monitoring data reported by the device meter 135B to determine demographic data for a subscriber associated with the media device identified by the device identifier, which is the media device 110B in the illustrated example. In the example operation 225, the service provider functionality 145 implemented by the service provider server 125 then sends reporting data to the AME server 130, which includes the demographic data, the received hashed media identifiers, the timestamp data and the device identifier (along with any other monitoring data received from the device meter 135B). In some examples, if the device identifier is not associated with any subscriber of the service provider, the service provider functionality 145 implemented by the service provider server 125 sets the demographic data associated with that device identifier to a NULL value or to a value indicating the demographic data is unknown, etc. In the illustrated example of FIG. 2, the AME server 130 then (1) cross-references the reported hashed media identifiers with their corresponding plaintext counterparts using a hash table that maps hashed media identifiers with their plaintext counterparts, (2) accesses descriptive data associated with the plaintext media identifiers, and then (3) combines the demographic data, timestamp data and any other reported data to determine audience measurement data characterizing the audience exposed to the media identified by the hashed media identifiers.

In some examples, in operation 225, the service provider server 125 sends separate reporting data to the AME server 130 for respective different device identifiers included in media monitoring data reported by the device meters 135A-C. In such examples, the AME server 130 is then able to associate demographic data with respective different device identifiers, which provides the potential to associate demographic data with particular device users. In some examples, in operation 225, the service provider server 125 sends aggregate reporting data to the AME server 130. In some such examples, the aggregate reporting data is aggregated by combining the demographic data determined for different device identifiers included in different reporting data from different device meters 135A-C, but which are associated with the same hashed media identifier. (In some examples, the service provider server 125 omits demographic data for a device identifier determined to not be associated with a service provider subscriber from the aggregated demographic data as the service provider does not have access to demographic data associated with that specific device identifier.) Although the service provider server 125 is unable to identify the particular media associated with a hashed media identifier, the service provider server 125 can ascertain that reported data from different device meters 135A-C is nevertheless associated with the same media if the reported hashed media identifiers are the same. As such, in some examples, the service provider server 125 aggregates demographic data associated with different device identifiers but with the same hashed media identifier to determine aggregate demographic data. Such an arrangement can preserve the privacy of the subscribers of the service provider, while still permitting the AME server to obtain demographic data in the aggregate and, thus, generate comprehensive audience measurement data for particular media associated with a particular hashed media identifier.

Although example audience measurement solutions using hashed media identifiers have been disclosed herein in the context of the example environment of use 100 of FIGS. 1 and 2, such solutions are not limited thereto. For example, the audience measurement system 105 may include any number(s) and/or type(s) of AME server(s) 130 and/or device meter(s) 135A-C, and/or may include media server metering functionality 140 implemented by any number(s) and/or type(s) of media provider server(s) 120 and/or service provider functionality 145 implemented by any number(s) and/or type(s) of service provider server(s).

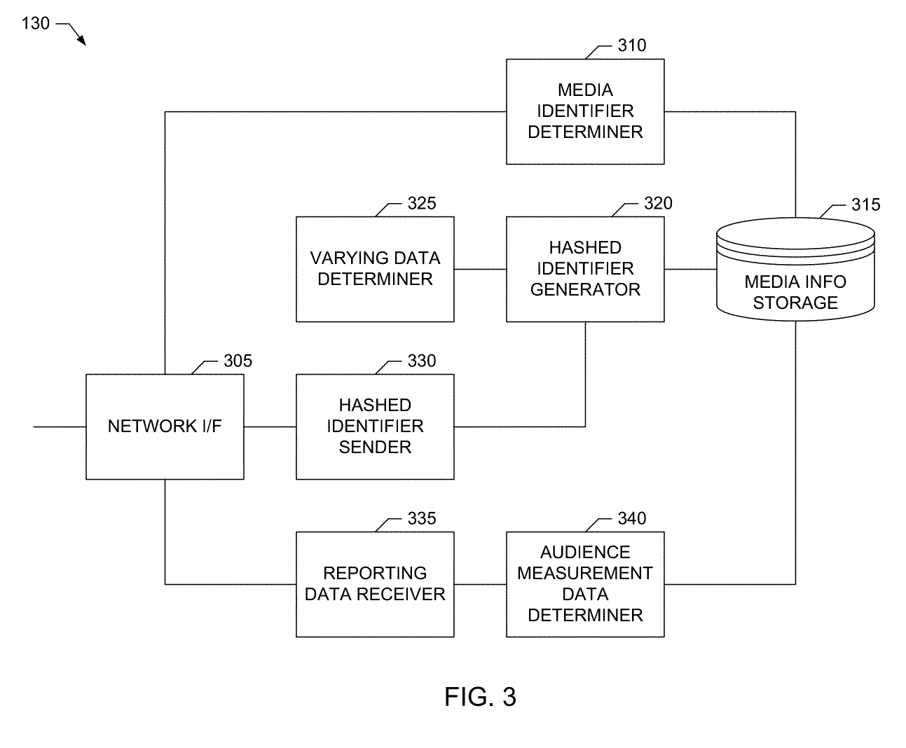

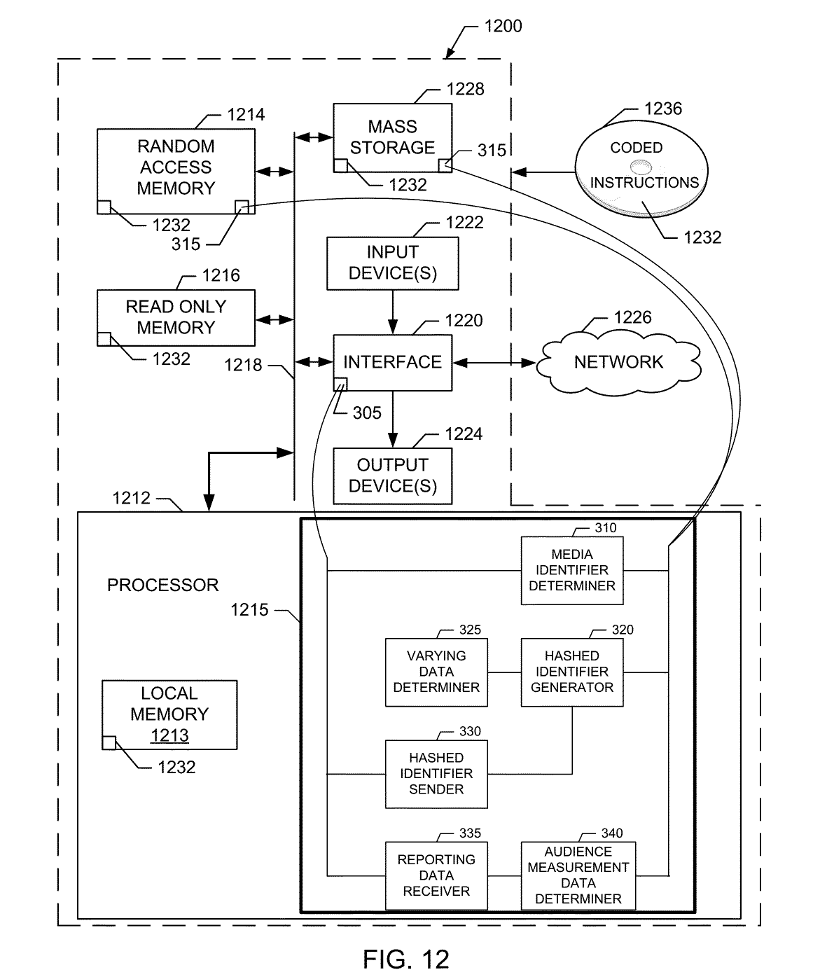

A block diagram of an example implementation of the AME server 130 of FIG. 1 is illustrated in FIG. 3. The example AME server 130 of FIG. 3 includes an example network interface (I/F) 305 to communicatively couple the AME server 130 to the example network 115 to thereby exchange digital data with one or more other devices, such as the example media provider server 120 and/or the example service provider server 125. As such, the example network I/F 305 may be implemented by any number and/or types(s) of network interfaces, such as, for example, the example interface circuit 1220 of FIG. 12, which is described in further detail below.

The example AME server 130 of FIG. 3 also includes an example media identifier determiner 310 to receive descriptive data for media to be monitored from, for example, the media provider server 120, and to determine plaintext media identifiers for that media. For example, the media identifier determiner 310 may receive descriptive data including a media identification information in the form of program identifiers (e.g., such as a name and/or other identifier of the media), source identifiers (e.g., such as a name and/or other identifier of the media provider and/or other source responsible for providing (e.g., streaming) the media to recipients), creator identifiers (e.g., identifying a production company, broadcaster, distributor, etc., responsible for creating the media), etc., for media accessible from the media provider server 120 In the illustrated example, the media identifier determiner 310 extracts the media identification information, which is in plaintext, from the received descriptive data, and stores the media identification information as plaintext media identifiers in an example media information storage 315. The media identifier determiner 310 also stores other descriptive information, such a program length, program genre, talent information, etc., in the media information storage 315 such that this descriptive information is linked to the appropriate plaintext media identifier identifying the media with which the descriptive information is associated. The example media information storage 315 may be implemented by any number and/or types(s) of memory and/or storage elements, such as one or more of the example volatile memory 1214 and/or the example mass storage device(s) 1228 of FIG. 12, which are described in further detail below.

The example AME server 130 of FIG. 3 further includes an example hashed identifier generator 320 to perform a hashing operation on a plaintext media identifier stored in the media information storage 315 to determine a hashed media identifier to also identify the same media identified by the plaintext media identifier. In the illustrated example of FIG. 3, the hashed identifier generator 320 implements one or more one-way hash functions to hash input plaintext media identifiers, which may have variable length, to generate output hashed media identifiers, which have a fixed length. Example one-way hash functions that may be implemented by the example hashed identifier generator 320 include, but are not limited to, one or more of the Secure Hash Algorithm (SHA) functions designed by the U.S. National Security Agency (e.g., such as SHA-256, SHA-512, etc.), one or more of the Message-Digest (MD) Algorithms, such as MD5, etc. As noted above, the hash function(s) implemented by the hashed identifier generator 320 are one-way such that a hashed media identifier can be generated from an input plaintext media identifier, but the original plaintext media identifier cannot be deduced directly without further information (e.g., such as a hash table) from the hashed media identifier.

In some examples, the hashed identifier generator 320 generates multiple hashed media identifiers to be associated with a single plaintext media identifier and, thus, which are to identify the same media. Having multiple hashed media identifiers for a single plaintext media identifier, with the hashed media identifiers changing over time, makes it even more difficult for an unauthorized user to deduce an original plaintext media identifier from one of its corresponding hashed media identifiers. In such examples, the AME server 130 includes an example varying data determiner 325 to obtain varying data to combine (e.g., concatenate) with an plaintext media identifier (e.g., obtained from the media information storage 315) to form an input data string to be hashed by the hashed identifier generator 320 to generate one of the set of hashed media identifiers to be associated with the input, plaintext media identifier. In some example, the varying data determiner 325 includes one or more random number generators and/or pseudo-random number generators to generate the varying data to be combined by hashed identifier generator 320 with an input, plaintext media identifier and then hashed to form the different hashed media identifiers associated with the input, plaintext media identifier.

In some examples, the varying data determiner 325 includes a clock and/or other timing source to generate date and time information that acts as the varying data to be combined with the input, plaintext media identifiers prior to hashing. For example, for each successive monitoring interval (e.g., such as one day or some other time interval) the hashed identifier generator 320 may be structured to generate a different hashed media identifier for the same plaintext media identifier (e.g., such as generating a different hashed media identifier on a daily basis). In such examples, the varying data determiner 325 may determine temporal data unique to a given monitoring time interval, such as the date and time of day corresponding to the monitoring time interval, to be used as the varying data to be combined by the hashed identifier generator 320 with the input, plaintext media identifier. For example, if each day corresponds to a new monitoring time interval, then the varying data determined by the varying data determiner 325 may correspond to the date corresponding to the start of the monitoring time interval in which the hashed media identifier is to be used, and the time of day (e.g., such as at 3:00 AM or some other time) corresponding to the start of that monitoring time interval. In such examples, the hashed identifier generator 320 may perform a hashing operation on a given plaintext media identifier combined with a first temporal data value (e.g., date and time) corresponding to a first monitoring time interval to generate a first hashed media identifier for use during the first monitoring time interval. The hashed identifier generator 320 may perform another hashing operation on the given plaintext media identifier combined with a second temporal data value (e.g., date and time) corresponding to a second monitoring time interval to generate a second hashed media identifier for use during the second monitoring time interval. The foregoing process may then continue to repeat for each successive monitoring time interval to generate different hashed media identifiers to be used for different successive monitoring intervals.

In the illustrated example of FIG. 3, the hashed identifier generator 320 stores the generated hashed media identifiers in an example hash table in the example media information storage 315. The hash table links or otherwise cross-references the hashed media identifiers to their respective plaintext media identifiers. In some examples, the hashed table may link or otherwise cross-reference multiple hashed media identifiers to a single plaintext media identifier (e.g., such as when the hashed identifier generator 320 generates different hashed identifiers from a single plaintext media identifier for use in different monitoring time intervals).

An example hash table is shown in Table 1. In the illustrated example of Table 1, the start of the monitoring time interval corresponds to 3:00 AM, and the table illustrates three respective hashed media identifiers linked to the plaintext media identifiers having values of 100, 200 and 300. The hash table also indicates the day and time corresponding to the monitoring time interval in which the hashed media identifier is to be used (and corresponding to the temporal data used to generate the respective hashed media identifiers).

TABLE 1

| | | Plaintext |
|---|---|---|
| | Temporal | Media |
| Hashed Media Identifier | Data | Identifier |
| 544b48a4b4883f01f70b2e5a15af838892f9e390f9b5f6781530dc991440ca37 | 5/3/2013, | 100 |
| | 03.00.00 | |
| e8bae386b8dfd1e07e41ba2c9bc77accdd8724b3bd388c499ff16d5344b3dba1 | 5/3/2013, | 200 |
| | 03.00.00 | |
| 86380eaed31e937fb4810bd62661a27124eb699e8ba3b452a1bdf9559c71d801 | 5/3/2013, | 300 |
| | 03.00.00 | |

The example AME server 130 of FIG. 3 includes an example hashed identifier sender 330 to send, via the example network I/F 305, the hashed media identifier(s) determined for respective ones of the plaintext media identifiers obtained from the descriptive data received from the media provider server 120 back to the media provider server 120 for conveying with media for audience measurement purposes. In some examples, the hashed identifier sender 330 sends a single hashed media identifier associated with a corresponding plaintext hashed media identifier, which the media provider server 120 is to convey with the particular media identified by the plaintext hashed media to permit the media to be identified when it is accessed and/or presented by a media device.

In some examples, the hashed identifier sender 330 sends multiple hashed media identifiers for a single corresponding plaintext hashed media identifier back to the media provider server 120, with the different hashed media identifiers to be conveyed with the particular media during different monitoring time intervals. In some such examples, the hashed identifier sender 330 sends the multiple hashed media identifiers and their respective monitoring time intervals together in a bulk transmission, and the media provider server 120 is responsible for determining when to use respective ones of the hashed media identifiers. In other such examples, the hashed identifier sender 330 sends respective ones of the multiple hashed media identifiers corresponding to a single corresponding plaintext hashed media identifier back individually to the media provider server 120 prior to start of the next monitoring time interval in which the hashed media identifier is to be used. For example, the hashed identifier sender 330 may send a first hashed media identifier associated with a given plaintext media identifier and a first monitoring time interval to the media provider server 120 before the start of the first monitoring time interval. The hashed identifier sender 330 may then send a second hashed media identifier associated with the given plaintext media identifier and a later second monitoring time interval to the media provider server 120 after sending the first hashed media identifier but before the start of the second monitoring time interval. This process may continue to repeat for additional hashed media identifiers to be used during subsequent monitoring time intervals.

In the illustrated example of FIG. 3, the AME server 130 includes an example reporting data receiver 335 to receive, via the network I/F 305, reporting data from one or more service provider servers, such as the example service provider server 125. As mentioned above, the reporting data received by the reporting data receiver 335 includes hashed media identifier(s) to identify media accessed and/or presented by media device(s) who reported the hashed media identifier(s) to the service provider server 125, demographic data corresponding to subscriber(s) associated with the media device(s) that reported the hashed media identifier(s), and/or any other media monitoring data reported for the media device(s). In some examples, the reporting data also includes timestamp data reported by the media device(s) to the service provider server 125 and indicating times at which the media device(s) accessed and/or presented the media associated with the hashed media identifier(s). The demographic data included in the reporting data received by the reporting data receiver 335 may include, but is not limited to, gender, age, income level, residence information (e.g., homeowner, renter, etc.), marital status, etc. In some example, the reporting data receiver 335 receives individual reporting data from the service provider server 125 for respective ones of the different media devices being monitored. In other examples, the demographic data included in the reporting data received by the reporting data receiver 335 has already been aggregated across different media devices based on the hashed media identifier(s). In such examples, the reporting data received by the reporting data receiver 335 may include a demographic profile associated with given hashed media identifier(s) at different times by aligning, based on the timestamp data, the different monitoring data associated with different ones of the media devices that reported the given hashed media identifier(s).

The example AME server 130 of FIG. 3 further includes an example audience measurement data determiner 340 to determine audience measurement data from the reporting data received from the service provider server 125 and from media information stored in the media information storage 315. For example, the audience measurement data determiner 340 accesses the hash table maintained in the media information storage 315 and uses the hash table to cross-reference the hashed media identifier(s) included in the reporting data received from the service provider server 125 with corresponding plaintext media identifier(s). The audience measurement data determiner 340 then uses the plaintext media identifier(s) to access the other descriptive data linked to the plaintext media identifier(s) in the media information storage 315 (e.g., by the media identifier determiner 310, as described above) to identify the particular media corresponding to the hashed media identifier(s) included in the reporting data. The audience measurement data determiner 340 further uses the timestamp data and demographic data included in the reporting data to determine audience measurement data for identified media and for the monitoring time intervals represented by the timestamp data and/or the temporal data stored in the hash table for the reported hashed media identifier(s). For example, the audience measurement data may characterize the demographic composition of the audience of particular media identified by the hashed media identifier(s) included in the reporting data and at different monitoring time intervals corresponding to the temporal data stored in the hash table for the reported hashed media identifier(s) and at a time granularity based on the time between successive timestamps in the reported data.

In some examples, the audience measurement data determiner 340 provides the audience measurement data to one or more customers of the AME. In such examples, the audience measurement data may be used by the customers to make decisions concerning media programming, advertising campaigns, etc.

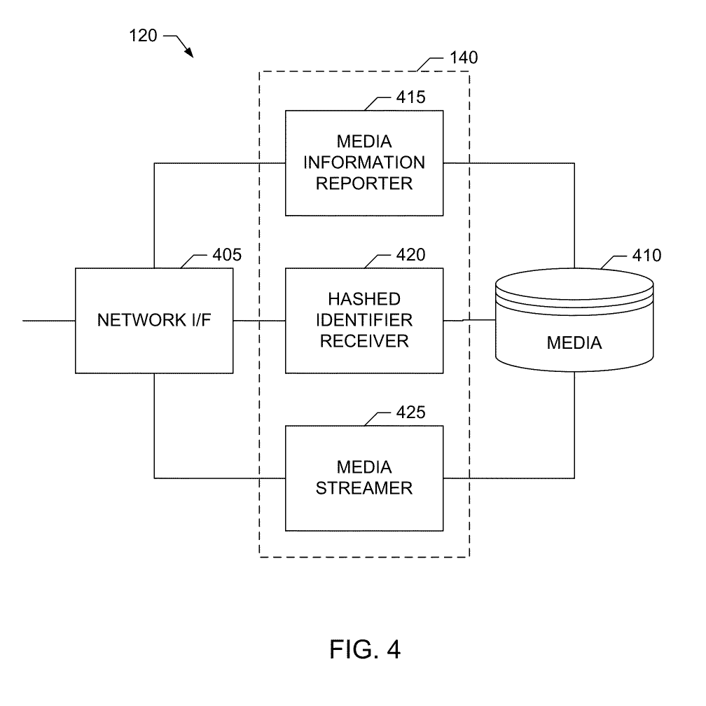

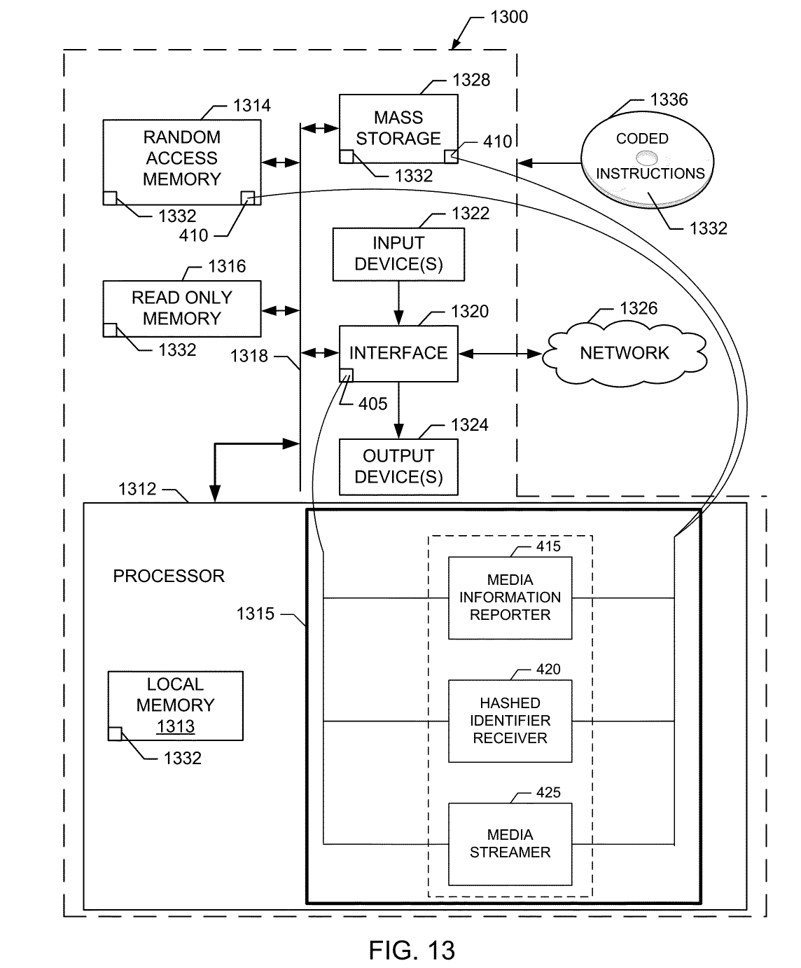

A block diagram of an example implementation of the media provider server 120 of FIG. 1 is illustrated in FIG. 4. The example media provider server 120 of FIG. 4 includes an example network interface (I/F) 405 to communicatively couple the media provider server 120 to the example network 115 to thereby exchange digital data with one or more other devices, such as the example media AME server 130 and/or the example service provider server 125. As such, the example network I/F 405 may be implemented by any number and/or types(s) of network interfaces, such as, for example, the example interface circuit 1320 of FIG. 13, which is described in further detail below.

The example media provider server 120 of FIG. 4 also includes example media storage 410 to store media, such as movies, television programs, advertisements, news clips, weather clips, etc., capable of being provided by the media provider server 120 to one or more media devices, such as the media devices 110A-C. The example media storage 410 also stores descriptive data characterizing the stored media. For example, such descriptive information can include, but is not limited to, media identification information in the form of program identifiers (e.g., such as a name and/or other identifier of the media), source identifiers (e.g., such as a name and/or other identifier of the media provider and/or other source responsible for providing (e.g., streaming) the media to recipients), creator identifiers (e.g., identifying a production company, broadcaster, distributor, etc., responsible for creating the media), etc., as well as other descriptive information, such a program length, program genre, talent information, etc. The example media storage 415 may be implemented by any number and/or types(s) of memory and/or storage elements, such as one or more of the example volatile memory 1314 and/or the example mass storage device(s) 1328 of FIG. 13, which are described in further detail below.

In the illustrated example of FIG. 4, the media provider server 120 includes an example media information reporter 415, an example hashed identifier receiver 420 and an example media streamer 425 to implement the example media provider functionality 140 described above in connection with FIG. 1. The media information reporter 415 of the illustrated example retrieves, from the media storage 410, the media identification information (e.g., such as the program identifiers, source identifiers, creator identifiers, etc.) for media to be monitored by the audience measurement system 105, and sends the media identification to the AME server 130 via the network I/F 405. The hashed identifier receiver 420 of the illustrated example receives, via the network I/F, one or multiple hashed media identifier(s) from the AME server 130 for respective ones of the media for which the media information reporter 415 sent media identification information to the AME server 130. In some examples, the hashed identifier receiver 420 receives a new (e.g., different) hashed media identifier for particular media to be monitored prior to the monitoring time interval during which the media provider server 120 is to use the hashed media identifier to identify the particular media. In some examples, the hashed identifier receiver 420 receives multiple hashed media identifiers for particular media to be monitored, and schedule information indicating when the media provider server 120 is to use respective ones of the multiple hashed media identifiers provided for the particular media. The hashed identifier receiver 420 then stores the provided hashed media identifier(s) for respective media in the media storage 410 for use when the media is to be provided to a recipient.

In the illustrated example of FIG. 4, the media streamer 425 is structured to embed or otherwise convey hashed media identifiers with media to be provided to a recipient, such as one or more of the media devices 110A-C, to permit the provided media to be monitored in the audience measurement system 105. When the media provider server 120 is to provide particular media to a recipient (e.g., in response to a request from the recipient), the media streamer 425 of the illustrated example retrieves the particular hashed media identifier to be used for the current monitoring time interval (e.g., the current day or some other interval) from the media storage 410. As noted above, different hashed media identifiers may be used to identify the same media in different monitoring time intervals. In some examples, the media streamer 425 includes the hashed media identifier in metadata accompanying the media provided to the recipient. For example, the media streamer 425 may include the hashed media identifier for the current monitoring time interval in ID3 tags accompanying the media, and/or include the hashed media identifier in the headers and/or other portions of the transport streams conveying the media, etc. In some examples, the media streamer 425 additionally or alternatively embeds the hashed media identifier as one or more watermarks in the media provided to the recipient. In the context of media monitoring, watermarks may be transmitted within media signals. For example, watermarks can be used to transmit data (e.g., such as identification codes, ancillary codes, etc.) with media (e.g., inserted into the audio, video, or metadata stream of media) to uniquely identify broadcasters and/or media (e.g., content or advertisements), and/or to convey other information. Watermarks are typically extracted using a decoding operation.

In contrast, signatures are a representation of some characteristic of the media signal (e.g., a characteristic of the frequency spectrum of the signal). Signatures can be thought of as fingerprints. Signatures are typically not dependent upon insertion of identification codes (e.g., watermarks) in the media, but instead preferably reflect an inherent characteristic of the media and/or the signal transporting the media. Systems to utilize codes (e.g., watermarks) and/or signatures for media monitoring are long known. See, for example, Thomas, U.S. Pat. No. 5,481,294, which is hereby incorporated by reference in its entirety.

Example watermarking techniques that may be implemented by the media streamer 425 to embed the hashed media identifiers as watermarks in provided (e.g., streamed) media include, but are not limited to, examples disclosed in U.S. Pat. No. 8,359,205, entitled “Methods and Apparatus to Perform Audio Watermarking and Watermark Detection and Extraction,” which issued on Jan. 22, 2013, U.S. Pat. No. 8,369,972, entitled “Methods and Apparatus to Perform Audio Watermarking Detection and Extraction,” which issued on Feb. 5, 2013, and U.S. Publication No. 2010/0223062, entitled “Methods and Apparatus to Perform Audio Watermarking and Watermark Detection and Extraction,” which was published on Sep. 2, 2010, all of which are hereby incorporated by reference in their respective entireties.

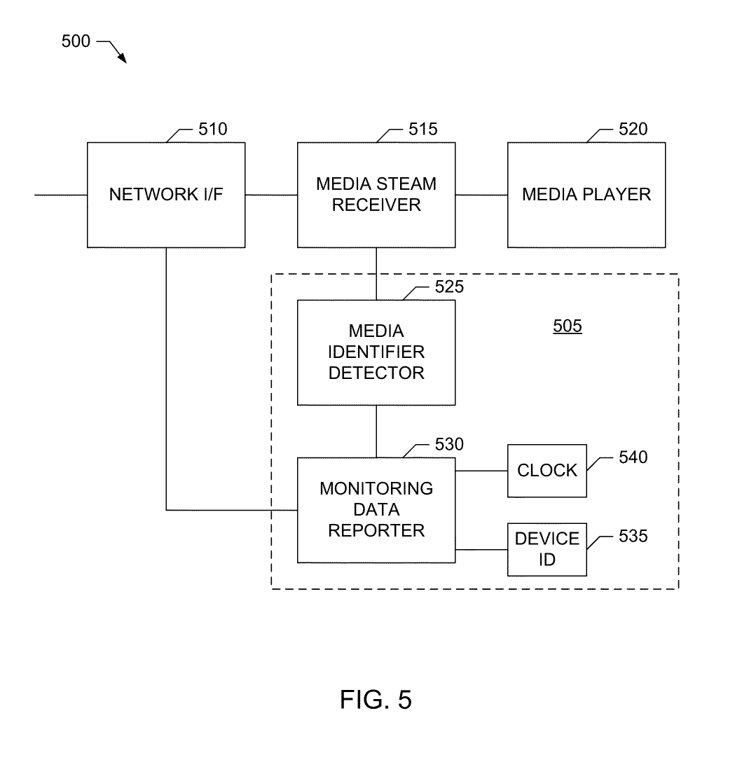

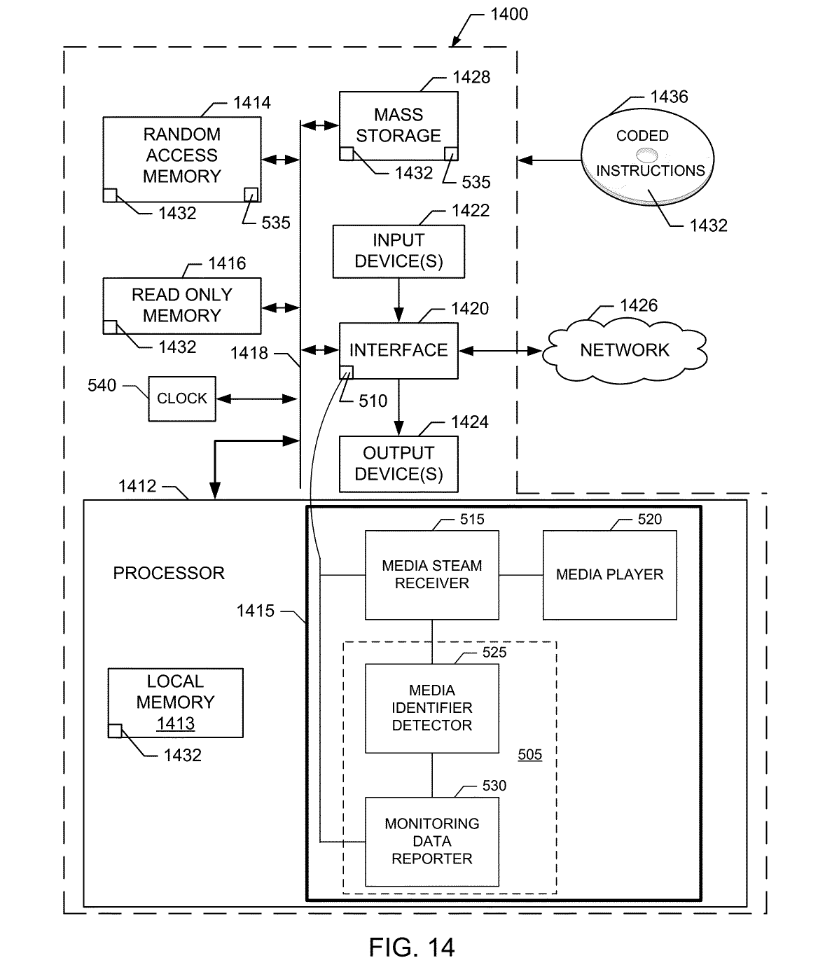

A block diagram of an example media device 500 that may be used to implement one or more of the example media devices 110A-C of FIG. 1 is illustrated in FIG. 5. In the illustrated example of FIG. 5, the media device 500 implements and/or is in communication with an example device meter 505 that may be used to implement one or more of the example device meters 135A-C of FIG. 1. The example device meter 505 may be implemented by software downloaded to and executed by the media device 500, or may be included in the media device 500 during manufacture, etc. For example, software to implement the device meter 505 may be downloaded to the media device 500 by the AME server 300 when a user consents to have his/her media device be monitored. Additionally or alternatively, the software to implement the device meter 505 may be downloaded to the media device 500 by the media provider server 120 and/or the service provider server 125 as a condition for a user of the media device 500 to be able to subscribe to a service(s) offered by the media provider and/or the service provider. The example media device 500 of FIG. 1 includes an example network interface (I/F) 510 to communicatively couple the media device 500 to the example network 115 to thereby exchange digital data with one or more other devices, such as the example media provider server 120 and/or the example service provider server 125. As such, the example network I/F 510 may be implemented by any number and/or types(s) of network interfaces, such as, for example, the example interface circuit 1420 of FIG. 14, which is described in further detail below.

The example media device 500 of FIG. 1 also includes an example media stream receiver 515 to access and receive one or more media transport streams conveying media from one or more media provider servers, such as the example media provider server 120. The example media device 500 of FIG. 1 further includes an example media player 520 to present the media conveyed via the media transport stream(s) received via the media stream receiver 515. The media stream receiver 515 and the media player 520 may be implemented using any media streaming and/or playing technology. However, the audience measurement solutions using hashed media identifiers disclosed herein are not limited to being used to monitor streaming media but, instead, can be used to monitor non-streaming media, such as media that is downloaded for playback at a later time, etc.

In the illustrated example of FIG. 5, the device meter 505 includes an example media identifier detector 525 to detect hashed media identifier(s) conveyed with the media received via the media stream receiver 515. In some examples, the media identifier detector 525 detects the hashed media identifiers in metadata accompanying the media received via the media stream receiver 515. For example, the media identifier detector 525 may detect hashed media identifiers included in ID3 tags accompanying the media, and/or included in the headers and/or other portions of the transport streams conveying media, etc. In some examples, the hashed media identifier(s) are embedded as watermark(s) in the media received via the media stream receiver 515. In some such examples, the media identifier detector 525 additionally or alternatively performs watermark detection to detect the hashed media identifier(s) in the embedded watermarks. Example watermark detection techniques that may be implemented by the example media identifier detector 525 include, but are not limited to, the examples disclosed in U.S. Pat. No. 8,359,205, U.S. Pat. No. 8,369,972 and U.S. Publication No. 2010/0223062 mentioned above and incorporated herein by reference.

The example device meter 505 of FIG. 5 also includes an example monitoring data reporter 530 to determine media monitoring data to be reported to one or more service provider server(s), such as the example service provider server 125. In the illustrated example of FIG. 5, the media monitoring data determined by the monitoring data reporter 530 includes the hashed media identifier(s) detected by the media identifier detector 525, and one or more example device identifiers 535 capable of identifying the media device 500. For example, the device identifier 535 can include, but is not limited to, one or more of a cookie stored on the media device 500, a network address of the media device 500, an Internet mobile station identity (IMEI) of the media device 500, etc.

In some examples, the media monitoring data determined by the monitoring data reporter 530 also includes timestamp data to indicate when the media identified by the hashed media identifier(s) was accessed and/or presented by the media device 500. For example, the online media monitoring data may include a sequence of data entries containing, among other things, respective hashed media identifier and timestamp pairs, with the timestamps being updated at regular or irregular time intervals (e.g., such as every 10 seconds, 15 seconds, 30 seconds, 1 minute, 5 minutes, etc.) and/or when certain events occur (e.g., such as when access and/or presentation of particular media is initiated, terminated, paused, etc.), etc., and/or combinations thereof. Accordingly, respective ones of such hashed media identifier and timestamp pairs indicate that the particular media identified by the hashed media identifier was accessed and/or presented for a time period corresponding to the duration between the timestamp in the data pair and, for example, the timestamp in the subsequent data pair. In such examples, the monitoring data reporter 530 receives temporal data (e.g., such as date and time data) from an example clock 540 and/or other timing device. The example monitoring data reporter 530 uses the temporal data to determine the timestamp data for inclusion in the media monitoring data.

As mentioned above, the monitoring data reporter 530 reports its determined media monitoring data to the service provider server 125 via the network I/F 510 (e.g., without contacting the AME server 130). Receipt of this media monitoring data triggers the service provider server 125 to determine demographic data for subscriber(s) associated with the device identifier 535 included in the reported media monitoring data. The service provider server 125 then reports this demographic data to the AME server 130, along with relaying the hashed media identifier(s) and timestamp data (and possibly the device identifier 535 and any other data) included in the media monitoring data. Thus, in the illustrated example, the monitoring data reporter 530 of the device meter 505 does not report its media monitoring data to the AME server 130 (and, more generally, the media device 500 does not communicate with the AME server 130). Instead, the service provider server 125 acts as a proxy for the AME server 130 by collecting and forwarding the data of interest to the AME server 130. (However, in other examples, the device meter 505 could report its monitoring data to the AME server 130, for example, for redundancy). Furthermore, because the hashed media identifier(s) included in the media monitoring data is(are) generated by one-way hash functions, the hashed media identifier(s) can be provided to the service provider server 125 without risk of the third-party service provider discovering the actual identity of particular media corresponding to the hashed media identifier(s).

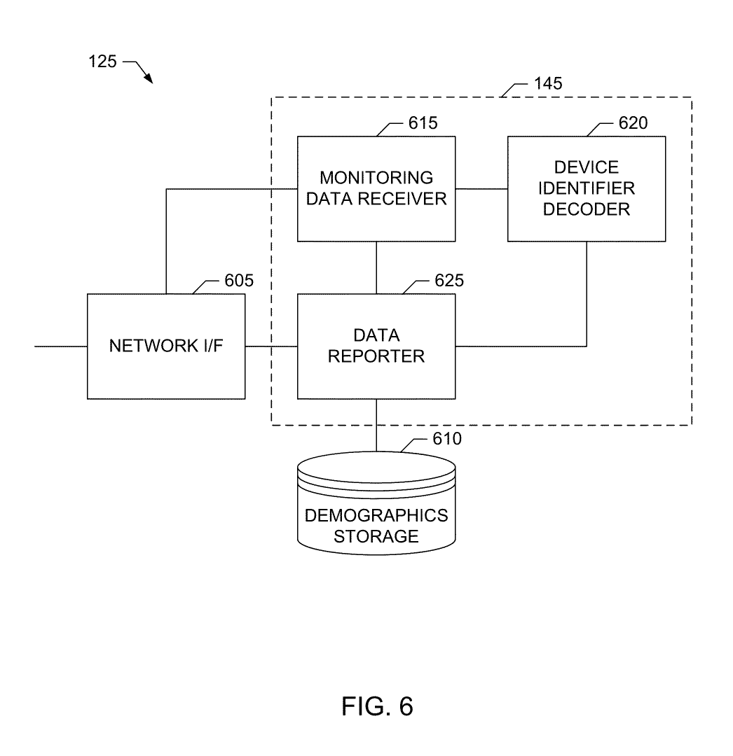

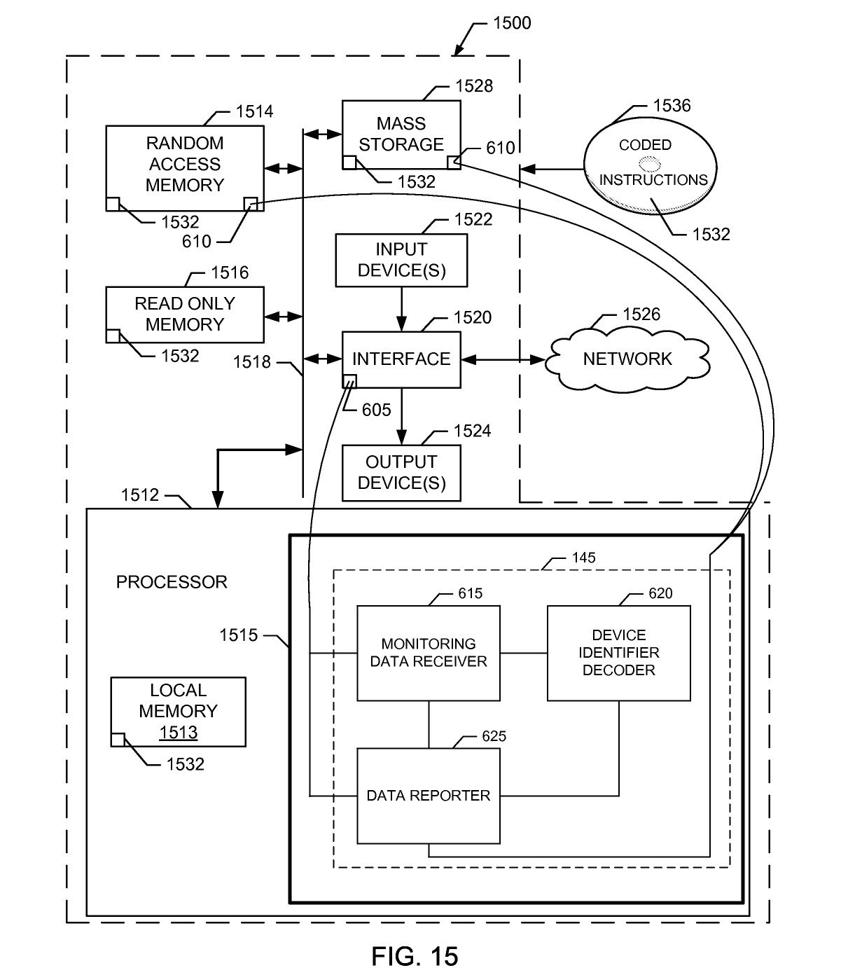

A block diagram of an example implementation of the service provider server 125 of FIG. 1 is illustrated in FIG. 6. The example service provider server 125 of FIG. 6 includes an example network interface (I/F) 605 to communicatively couple the service provider server 125 to the example network 115 to thereby exchange digital data with one or more other devices, such as the example media AME server 130 and/or the example media provider server 120. As such, the example network I/F 605 may be implemented by any number and/or types(s) of network interfaces, such as, for example, the example interface circuit 1520 of FIG. 15, which is described in further detail below.

The example service provider server 125 of FIG. 6 also includes example demographics data storage 610 to store demographic data associated with subscriber(s) of the service provider. For example, the demographic data stored in the demographics data storage 610 for respective service provider subscribers may include, but is not limited to, name information, address information, billing information, gender, age, income level, residence information (e.g., homeowner, renter, etc.), marital status, etc., provided by the subscribers of the associated service provider when the subscribers sign-up for service. The example demographics data storage 610 may be implemented by any number and/or types(s) of memory and/or storage elements, such as one or more of the example volatile memory 1514 and/or the example mass storage device(s) 1528 of FIG. 15, which are described in further detail below.

In the illustrated example of FIG. 6, the service provider server 125 includes an example monitoring data receiver 615, an example device identifier decoder 620 and an example data reporter 625 to implement the example service provider functionality 145 described above in connection with FIG. 1. The monitoring data receiver 615 of the illustrated example receives media monitoring data from one or more media devices and/or media device meters, such as the media device meters 135A-C and/or 505. As described above, the received media monitoring data includes, for example, hashed media identifier(s) corresponding to media accessed and/or presented by the media device monitored by the reporting device meter, timestamp data indicating when the media corresponding to the hashed media identifier(s) was accessed and/or presented, and device identifier(s), such as the device identifier 535, identifying the media device for which the received media monitoring data was reported. The device identifier decoder 620 of the illustrated example accesses the device identifier(s) included in the reported media monitoring data received by the monitoring data receiver 615. As described above, the device identifier(s) may include, for example, cookie(s) stored on the media device(s), network address(es) of the media device(s), IMEI(s) of the media device(s), etc. In some examples, the device identifier decoder 620 further maps the received device identifier(s) to one or more subscriber identifiers that may be used to access demographic data in the demographics data storage 619. For example, the subscriber identifiers may include, but are not limited to, subscriber account number(s), subscriber username(s), etc., identifying the subscriber(s) associated with the media device(s) identified by the device identifier(s) included in the received media monitoring data.

The data reporter 625 of the illustrated example uses the device identifier(s) (and/or associated subscriber identifier(s)) determined by the device identifier decoder 620 to access the demographics data storage 610 and to determine demographics data for the subscriber(s) associated with the media device(s) identified by the device identifier(s) included in the received media monitoring data. The data reporter 625 then includes this demographics data in reporting data to be reported to the AME server 130. Additionally, the data reporter 625 includes the hashed media identifier(s), timestamp data, and possibly the device identifier(s) (and/or any other data in the media monitoring data received by the monitoring data receiver 615) in its reporting data to relay such information from the reporting media device meter(s) to the AME server 130. As noted above, it is unnecessary for the media device meter(s) (e.g., such as the device meters 135A-C and/or 505) to report media monitoring data directly to the AME server 130 because service provider server 125 will relay such media monitoring data in its reporting data determined by the data reporter 625. Thus, in some examples, network traffic is reduced and the amount of messaging required for the AME is reduced relative to prior art audience measurement systems because, for example, the AME server 130 does not need to support receiving data from each individual device meter in the audience measurement system 105. Furthermore, because the hashed media identifier(s) to be relayed from the device meter(s) to the AME server 130 are generated by one-way hash functions, the hashed media identifier(s) can be provided to the service provider server 125 without risk of the third-party service provider discovering the actual identity of particular media corresponding to the hashed media identifier(s).

In some examples, the data reporter 625 of the service provider server 125 determines and sends separate reporting data including separate demographic data to the AME server 130 for respective different device identifiers included in the media monitoring data received by the monitoring data receiver 615. Additionally or alternatively, in some examples, the data reporter 625 determines and sends aggregate reporting data to the AME server 130, which is aggregated by combining the demographic data determined for different device identifiers included in different reporting data received by the monitoring data receiver 615, but which are associated with the same hashed media identifier. As mentioned above, although the data reporter 625 is unable to identify the particular media associated with a hashed media identifier (due to the one-way hash function used to generate the hashed media identifier), the service provider server 125 can ascertain that media monitoring data received from different device meters is nevertheless associated with the same media if the reported hashed media identifiers are the same. As such, in some examples, the data reporter 625 aggregates the demographic data associated with different device identifiers but with the same hashed media identifier and over a same time range (e.g., based on the received timestamp data) to determine aggregate demographic data, which is reported to the AME server with the hashed media identifier and time range over which the demographic data represents the aggregate composition of the audience exposed to the media identified by the hashed media identifier.

While example manners of implementing the audience measurement system 105 are illustrated in FIGS. 1-6, one or more of the elements, processes and/or devices illustrated in FIGS. 1-6 may be combined, divided, re-arranged, omitted, eliminated and/or implemented in any other way. Further, the example media devices 110A-C, the example network 115, the example media provider server 120, the example service provider server 125, the example AME server 130, the example device meters 135A-C, the example media server metering functionality 140, the example service provider functionality 145, the example network I/F 305, the example media identifier determiner 310, the example media information storage 315, the example hashed identifier generator 320, the example varying data determiner 325, the example hashed identifier sender 330, the example reporting data receiver 335, the example audience measurement data determiner 340, the example network I/F 405, the example media storage 410, the example media information reporter 415, the example hashed identifier receiver 420, the example media streamer 425, the example device meter 505, the example network I/F 510, the example media stream receiver 515, the example media player 520, the example media identifier detector 525, the example monitoring data reporter 530, the example clock 540, the example network I/F 605, the example demographics data storage 610, the example monitoring data receiver 615, the example device identifier decoder 620, the example data reporter 625 and/or, more generally, the example audience measurement system 105 of FIGS. 1-6 may be implemented by hardware, software, firmware and/or any combination of hardware, software and/or firmware. Thus, for example, any of the example media devices 110A-C, the example network 115, the example media provider server 120, the example service provider server 125, the example AME server 130, the example device meters 135A-C, the example media server metering functionality 140, the example service provider functionality 145, the example network I/F 305, the example media identifier determiner 310, the example media information storage 315, the example hashed identifier generator 320, the example varying data determiner 325, the example hashed identifier sender 330, the example reporting data receiver 335, the example audience measurement data determiner 340, the example network I/F 405, the example media storage 410, the example media information reporter 415, the example hashed identifier receiver 420, the example media streamer 425, the example device meter 505, the example network I/F 510, the example media stream receiver 515, the example media player 520, the example media identifier detector 525, the example monitoring data reporter 530, the example clock 540, the example network I/F 605, the example demographics data storage 610, the example monitoring data receiver 615, the example device identifier decoder 620, the example data reporter 625 and/or, more generally, the example audience measurement system 105 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example audience measurement system 105, the example media devices 110A-C, the example network 115, the example media provider server 120, the example service provider server 125, the example AME server 130, the example device meters 135A-C, the example media server metering functionality 140, the example service provider functionality 145, the example network I/F 305, the example media identifier determiner 310, the example media information storage 315, the example hashed identifier generator 320, the example varying data determiner 325, the example hashed identifier sender 330, the example reporting data receiver 335, the example audience measurement data determiner 340, the example network I/F 405, the example media storage 410, the example media information reporter 415, the example hashed identifier receiver 420, the example media streamer 425, the example device meter 505, the example network I/F 510, the example media stream receiver 515, the example media player 520, the example media identifier detector 525, the example monitoring data reporter 530, the example clock 540, the example network I/F 605, the example demographics data storage 610, the example monitoring data receiver 615, the example device identifier decoder 620 and/or the example data reporter 625 is/are hereby expressly defined to include a tangible computer readable storage device or storage disk such as a memory, a digital versatile disk (DVD), a compact disk (CD), a Blu-ray disk, etc. storing the software and/or firmware. Further still, the example audience measurement system 105 may include one or more elements, processes and/or devices in addition to, or instead of, those illustrated in FIGS. 1-6, and/or may include more than one of any or all of the illustrated elements, processes and devices.

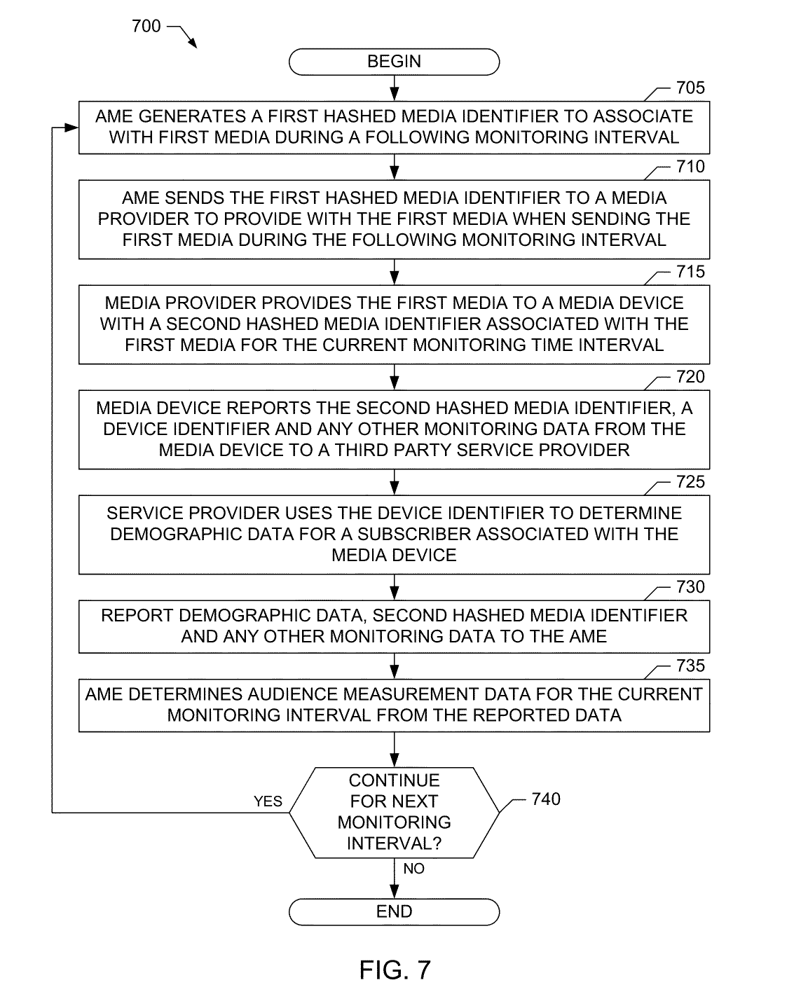

Flowcharts representative of example machine readable instructions for implementing the example audience measurement system 105, the example media devices 110A-C, the example network 115, the example media provider server 120, the example service provider server 125, the example AME server 130, the example device meters 135A-C, the example media server metering functionality 140, the example service provider functionality 145, the example network I/F 305, the example media identifier determiner 310, the example media information storage 315, the example hashed identifier generator 320, the example varying data determiner 325, the example hashed identifier sender 330, the example reporting data receiver 335, the example audience measurement data determiner 340, the example network I/F 405, the example media storage 410, the example media information reporter 415, the example hashed identifier receiver 420, the example media streamer 425, the example device meter 505, the example network I/F 510, the example media stream receiver 515, the example media player 520, the example media identifier detector 525, the example monitoring data reporter 530, the example clock 540, the example network I/F 605, the example demographics data storage 610, the example monitoring data receiver 615, the example device identifier decoder 620 and/or the example data reporter 625 are shown in FIGS. 7-11. In these examples, the machine readable instructions comprise one or more programs for execution by a processor, such as the processors 1212, 1312, 1412 and/or 1512 shown in the example processor platforms 1200, 1300, 1400 and 1500, respectively, discussed below in connection with FIGS. 12-15. The one or more programs, or portion(s) thereof, may be embodied in software stored on a tangible computer readable storage medium such as a CD-ROM, a floppy disk, a hard drive, a digital versatile disk (DVD), a Blu-ray disk™, or a memory associated with the processor 1212, 1312, 1412 and/or 1512, but the entire program or programs and/or portions thereof could alternatively be executed by a device other than the processor 1212 1312, 1412 and/or 1512, and/or embodied in firmware or dedicated hardware (e.g., implemented by an ASIC, a PLD, an FPLD, discrete logic, etc.). Further, although the example program(s) is(are) described with reference to the flowcharts illustrated in FIGS. 7-11, many other methods of implementing the example audience measurement system 105, the example media devices 110A-C, the example network 115, the example media provider server 120, the example service provider server 125, the example AME server 130, the example device meters 135A-C, the example media server metering functionality 140, the example service provider functionality 145, the example network I/F 305, the example media identifier determiner 310, the example media information storage 315, the example hashed identifier generator 320, the example varying data determiner 325, the example hashed identifier sender 330, the example reporting data receiver 335, the example audience measurement data determiner 340, the example network I/F 405, the example media storage 410, the example media information reporter 415, the example hashed identifier receiver 420, the example media streamer 425, the example device meter 505, the example network I/F 510, the example media stream receiver 515, the example media player 520, the example media identifier detector 525, the example monitoring data reporter 530, the example clock 540, the example network I/F 605, the example demographics data storage 610, the example monitoring data receiver 615, the example device identifier decoder 620 and/or the example data reporter 625 may alternatively be used. For example, with reference to the flowcharts illustrated in FIGS. 7-11, the order of execution of the blocks may be changed, and/or some of the blocks described may be changed, eliminated, combined and/or subdivided into multiple blocks.

As mentioned above, the example processes of FIGS. 7-11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7-11 may be implemented using coded instructions (e.g., computer and/or machine readable instructions) stored on a non-transitory computer and/or machine readable medium such as a hard disk drive, a flash memory, a ROM, a CD, a DVD, a cache, a RAM and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. Also, as used herein, the terms “computer readable” and “machine readable” are considered equivalent unless indicated otherwise.

An example process 700 that may be performed by the example audience measurement system 105 to determine audience measurement data using hashed media identifiers in the example environment of use 100 is represented by the flowchart shown in FIG. 7. The example program 700 may be executed at predetermined intervals, based on an occurrence of a predetermined event, etc., or any combination thereof. With reference to the preceding figures and associated written descriptions, the example process 700 of FIG. 7 begins execution at block 705 at which the example AME server 130 generates a first hashed media identifier to associate with first media during a subsequent monitoring time interval. As described above, the AME server 130 generates the first hashed media identifier from a plaintext media identifier associated with the first media and, in some examples, varying data such that different hashed media identifiers are generated for the same first media but for use in different monitoring time intervals.

At block 710, the AME server 130 sends the first hashed media identifier to the example media provider server 120. As described above, the media provider server 120 is to provide the first hashed media identifier with the first media if/when the media provider server 120 sends the first media to a media device (e.g., one or more of the example media devices 110A-C) during the subsequent monitoring time interval. Assuming the media provider server 120 is to provide the first media to a media device during a current monitoring time interval (e.g., which is earlier than the subsequent time interval), at block 715 the media provider server 120 provides the first media to the media device with a second hashed media identifier (e.g., which may be different from the first hashed media identifier) that was previously generated for the first media and for use during the current monitoring time interval.

At block 720, the media device detects the second hashed media identifier provided with the first media, and reports the second hashed media identifier, a device identifier (e.g., such as the device identifier 535) identifying the media device, timestamp data and any other media monitoring data to the example service provider server 125. In some examples, the device identifier, timestamp data and other media monitoring data are sent in plaintext format, whereas any media identifiers are hashed (or otherwise obfuscated). In other examples, the timestamp data and/or other monitoring data may also be obfuscated by a hashing function, encryption function, etc., implemented by the media device (or its associated device meter), whereas the device identifier is sent in plaintext to permit usage by the service provider server 125. At block 725, the service provider server 125 uses the device identifier included in the media monitoring data reported at block 720 to determine demographic data for a service provider subscriber associated with the media device identified by the device identifier. At block 730, the service provider server 125 reports the demographic data, the second hashed identifier, the timestamp data and any other media monitoring data (e.g., to be relayed by the service provider server 125) to the AME server 130. At block 735, the AME server determines audience measurement data for the current monitoring interval based on the second hashed media identifier, the timestamp data, the demographic data and any other media monitoring data received at block 730.

If monitoring is to continue for the next monitoring interval (block 740), the example process 700 returns to block 705 and blocks subsequent thereto. In some examples, the example process 700 is repeated by the audience measurement system 105 for second media, third media, fourth media, etc., to generate hashed media identifiers for that media and to use the hashed media identifiers to determine audience measurement data for the second media, third media, fourth media, etc.

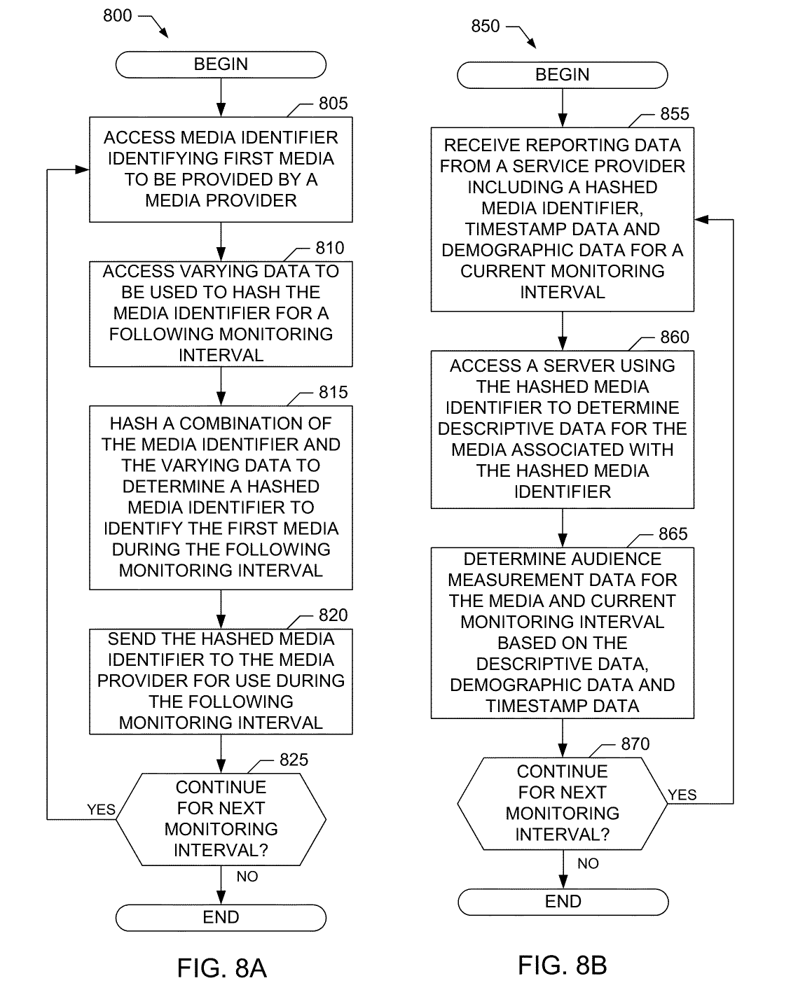

A first example program 800 that may be executed to implement the example AME server 130 of FIGS. 1-3 is represented by the flowchart shown in FIG. 8A. For convenience and without loss of generality, execution of the first example program 800 is described in the context of the example AME server 130 of FIG. 3 operating in the example environment of use 100 of FIG. 1. With reference to the preceding figures and associated written descriptions, the example program 800 of FIG. 8A begins execution at block 805 at which the hashed identifier generator 320 of the AME server 130 accesses (e.g., from the example media information storage 315) a plaintext media identifier identifying first media to be provided by the example media provider server 120 and to be monitored by the example audience measurement system 105. At block 810, the hashed identifier generator 320 accesses varying data determined by the example varying data determiner 325 for use in generating a hashed media identifier for a following monitoring time interval. For example, the varying data can be a day and time corresponding to the following monitoring time interval (e.g., such as 3:00 AM or some other time on the day corresponding to the monitoring time interval during which the hashed media identifier being generated is to be used), a random number, etc.

At block 815, the hashed identifier generator 320 combines (e.g., concatenates, etc.) the plaintext media identifier accessed at block 805 with the varying data accessed at block 810 and processes the combined data with a one-way hash function to determine a hashed media identifier to identify the first media during the following monitoring time interval. At block 820, the example hashed identifier sender 330 of the AME server 130 sends the hashed media identifier generated at block 815 to the example media provider server 129 for use during the following time interval.

If monitoring is to continue for the next monitoring interval (block 825), the example program 800 returns to block 805 and blocks subsequent thereto at which the AME server 130 generates a new hashed media identifier for the same first media but for use during a subsequent monitoring time interval. In some examples, execution of the example program 800 is repeated for second media, third media, fourth media, etc., to generate hashed media identifiers for that media and to send the hashed media identifiers to the example media provider server 120 for conveying with the second media, third media, fourth media, etc.

A second example program 850 that may be executed to implement the example AME server 130 of FIGS. 1-3 is represented by the flowchart shown in FIG. 8B. For convenience and without loss of generality, execution of the first example program 850 is described in the context of the example AME server 130 of FIG. 3 operating in the example environment of use 100 of FIG. 1. With reference to the preceding figures and associated written descriptions, the example program 850 of FIG. 8B begins execution at block 855 at which the example reporting data receiver 335 of the AME server 130 receives reporting data from the example service provider server 125. As described above, the reporting data includes hashed media identifier(s), timestamp data and demographic data for the current monitoring interval. At block 860, the example audience measurement data determiner 340 of the AME server 130 accesses a hash table maintained in the example media information storage 315 to cross-reference the received hashed media identifier(s) with corresponding plaintext media identifier(s) and/or other descriptive data associated with the received hashed media identifier(s) to identify the particular media corresponding to the hashed media identifier(s). At block 865, the audience measurement data determiner 340 uses the descriptive data accessed at block 860 and the demographic and timestamp data received at block 855 to determine audience measurement data characterizing the audience of the media corresponding to the hashed media identifier(s), as described above. If monitoring is to continue for the next monitoring interval (block 855), the example program 850 returns to block 855 and blocks subsequent thereto.

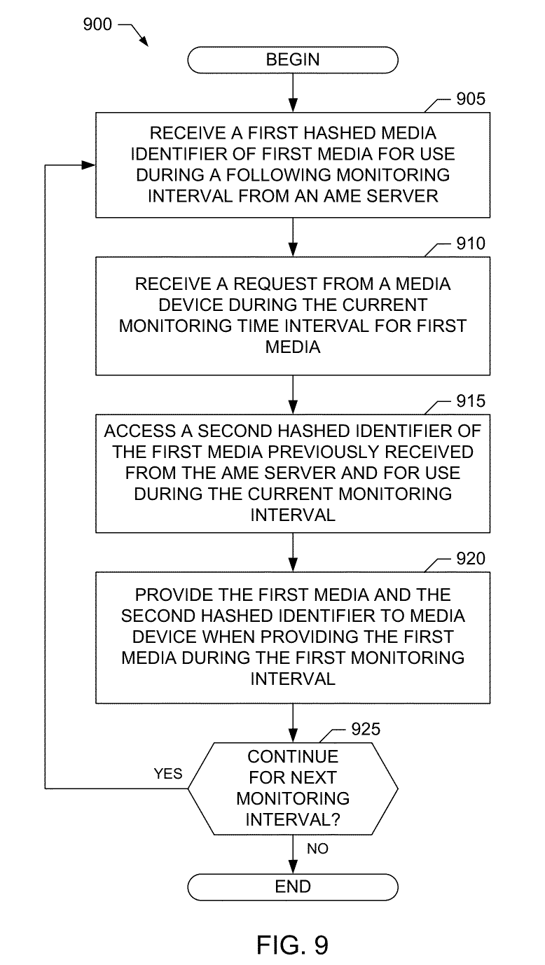

An example program 900 that may be executed to implement the example media provider server 120 of FIGS. 1, 2 and/or 4 is represented by the flowchart shown in FIG. 9. For convenience and without loss of generality, execution of the example program 900 is described in the context of the example media provider server 120 of FIG. 4 operating in the example environment of use 100 of FIG. 1. With reference to the preceding figures and associated written descriptions, the example program 900 of FIG. 9 begins execution at block 905 at which the example hashed identifier receiver 420 of the media provider server 120 receives a first hashed media identifier of first media from the example AME server 130 to be used to monitor the first media during a following monitoring time interval. At block 905, the hashed identifier receiver 420 also stores the first hashed media identifier in the example media storage 410 such that the first hashed media identifier is linked to the first media. At block 910, the example media streamer 425 of the media provider server 120 receives, during the current monitoring time interval, a request from a media device (e.g., such as one of the media devices 110A-C and/or 500) for the first media. Assuming the current monitoring time interval is different from (e.g., earlier than) the following monitoring time interval during which the first hashed media identifier is to be used, at block 915 the example media streamer 425 of the media provider server 120 accesses a second hashed media identifier stored in the media storage 410 for the first media and to be used during the current monitoring time interval. At block 920, the media streamer 425 provides the requested first media with the second hashed media identifier to the media device during the current monitoring time interval, as described above.

If monitoring is to continue for the next monitoring interval (block 925), the example program 900 returns to block 905 and blocks subsequent thereto at which the media provider server 120 receives and uses different hashed media identifiers in subsequent monitoring time intervals. In some examples, execution of the example program 900 is repeated for second media, third media, fourth media, etc., to cause hashed media identifiers for that media to be sent by the example media provider server 120 when conveying the second media, third media, fourth media, etc., to requesting media devices.

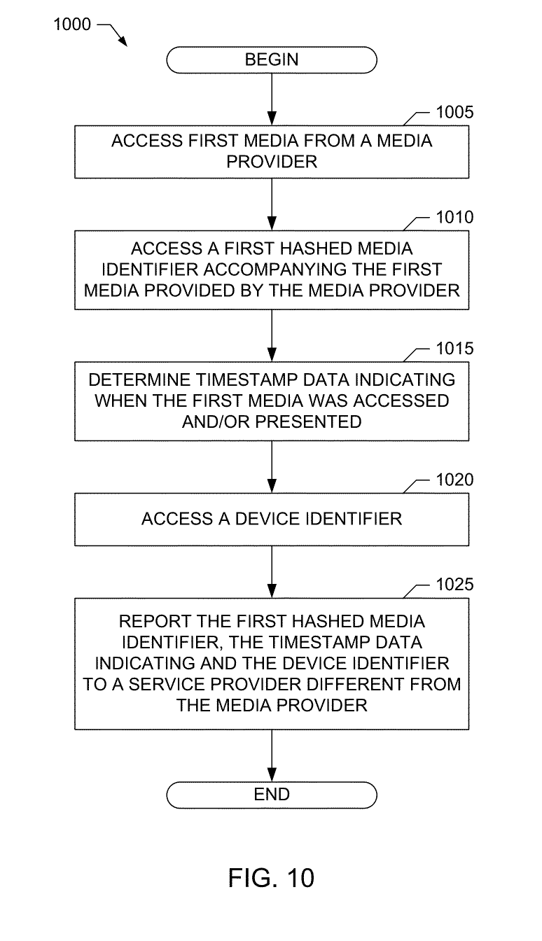

An example program 1000 that may be executed to implement one or more of the media devices 110A-C and/or 500, and/or one or more of the device meters 135A-C and/or 505, is represented by the flowchart shown in FIG. 10. For convenience and without loss of generality, execution of the example program 1000 is described in the context of the example media device 500 and the example device meter 505 of FIG. 5 operating in the example environment of use 100 of FIG. 1. With reference to the preceding figures and associated written descriptions, the example program 1000 of FIG. 10 begins execution at block 1005 at which the example media identifier detector 525 of the media device 500 accesses first media received via the media stream receiver 515 from the media provider server 120. At block 1010, the media identifier detector 525 accesses, as described above, a first hashed media identifier accompanying the first media streamed from the media provider server 120. At block 1015, the example monitoring data reporter 530 of the media device 500 determines timestamp data indicating when the first media was accessed and/or presented by the media device 500. At block 1020, the monitoring data reporter 530 accesses the device identifier 535, which identifies the media device. At block 1025, the monitoring data reporter 530 determines media monitoring data including the first hashed media identifier, the timestamp data and the device identifier (as well as any other media monitoring data), and reports the determined media monitoring data to the example service provider server 125.

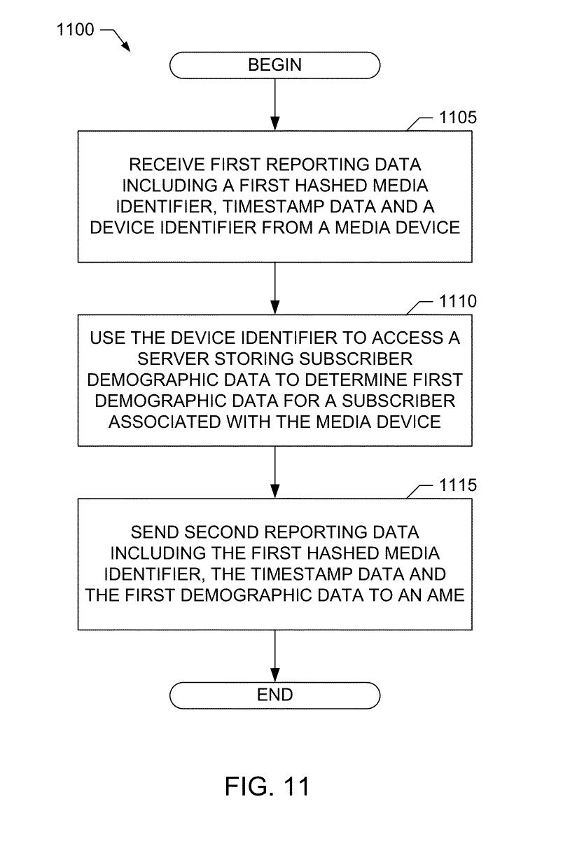

An example program 1100 that may be executed to implement the example service provider server 125 of FIGS. 1, 2 and/or 6 is represented by the flowchart shown in FIG. 11. For convenience and without loss of generality, execution of the example program 1100 is described in the context of the example service provider server 125 of FIG. 6 operating in the example environment of use 100 of FIG. 1. With reference to the preceding figures and associated written descriptions, the example program 1100 of FIG. 11 begins execution at block 1105 at which the example monitoring data receiver 615 of the service provider server 125 receives first reporting data (e.g., also referred to herein as media monitoring data) from a media device (e.g., such as one of the media devices 110A-C and/or 500), or from a device meter (e.g., such as one of the device meters 135A-C and/or 505) associated with the media device. As described above, the first reporting data received at block 1105 includes a first hashed media identifier associated with media accessed and/or presented at the media device during the current monitoring time interval, timestamp data indicating when the media associated with the first hashed media identifier was accessed and/or presented, and a device identifier (e.g., such as the device identifier 535) identifying the media device.

At block 1110, the example data reporter 625 of the service provider server 125 uses the device identifier obtained at block 1105 to access the example demographics data storage 610 to determine demographic data for subscriber(s) associated with the media device identified by the device identifier, as described above. At block 1115, the data reporter 625 includes the demographic data obtained at block 1110, and the first hashed media identifier, the timestamp data and, in some examples, the device identifier obtained at block 1105, in second reporting data, which the data reporter 625 sends to the AME server 130 for use in generating audience measurement data for the media identified by the first hashed media identifier and for the current monitoring time interval.

FIG. 12 is a block diagram of an example processor platform 1200 structured to execute the instructions of FIGS. 7, 8A and/or 8B to implement the example AME server 130 of FIGS. 1-3. The processor platform 1200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. In the illustrated example of FIG. 12, the processor 1212 includes one or more example processing cores 1215 configured via example instructions 1232 to implement the example AME server 130, the example media identifier determiner 310, the example hashed identifier generator 320, the example varying data determiner 325, the example hashed identifier sender 330 and/or the example reporting data receiver 335 of FIGS. 1-3.

The processor 1212 of the illustrated example includes a local memory 1213 (e.g., a cache). The processor 1212 of the illustrated example is in communication with a main memory including a volatile memory 1214 and a non-volatile memory 1216 via a link 1218. The link 1218 may be implemented by a bus, one or more point-to-point connections, etc., or a combination thereof. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1200, can allow the user to control the computer system and provide data to the computer using physical gestures, such as, but not limited to, hand or body movements, facial expressions, and face recognition.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.). In the illustrated example of FIG. 12, the interface circuit is also structured to implement the example network I/F 305 of the AME server 130.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID (redundant array of independent disks) systems, and digital versatile disk (DVD) drives. In some examples, the mass storage device 1228 may implement the example media information storage 315. Additionally or alternatively, in some examples the volatile memory 1214 may implement the example media information storage 315.

Coded instructions 1232 corresponding to the instructions of FIGS. 7, 8A and/or 8B may be stored in the mass storage device 1228, in the volatile memory 1214, in the non-volatile memory 1216, in the local memory 1213 and/or on a removable tangible computer readable storage medium, such as a CD or DVD 1236.

FIG. 13 is a block diagram of an example processor platform 1300 structured to execute the instructions of FIGS. 7 and/or 9 to implement the example media provider server 120 of FIGS. 1, 2 and/or 4. The processor platform 1300 can be, for example, a server, a personal computer, a mobile device (e.g., a cell phone, a smart phone, a tablet such as an iPad™), a PDA, an Internet appliance, a DVD player, a CD player, a digital video recorder, a Blu-ray player, a gaming console, a personal video recorder, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer. In the illustrated example of FIG. 13, the processor 1312 includes one or more example processing cores 1315 configured via example instructions 1332 to implement the example media provider server 120, the example media information reporter 415, the example hashed identifier receiver 420 and/or the example media streamer 425 of FIGS. 1, 2 and/or 4.

The processor 1312 of the illustrated example includes a local memory 1313 (e.g., a cache). The processor 1312 of the illustrated example is in communication with a main memory including a volatile memory 1314 and a non-volatile memory 1316 via a link 1318. The link 1318 may be implemented by a bus, one or more point-to-point connections, etc., or a combination thereof. The volatile memory 1314 may be implemented by SDRAM, DRAM, RDRAM and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a USB, and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1300, can allow the user to control the computer system and provide data to the computer using physical gestures, such as, but not limited to, hand or body movements, facial expressions, and face recognition.

One or more output devices 1324 are also connected to the interface circuit 1320 of the illustrated example. The output devices 1324 can be implemented, for example, by display devices (e.g., an LED, an OLED, a liquid crystal display, a CRT, a touchscreen, a tactile output device, a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a DSL, a telephone line, coaxial cable, a cellular telephone system, etc.). In the illustrated example of FIG. 13, the interface circuit is also structured to implement the example network I/F 405 of the media provider server 120.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and DVD drives. In some examples, the mass storage device 1328 may implement the example media storage 410. Additionally or alternatively, in some examples the volatile memory 1314 may implement the example media storage 410.

Coded instructions 1332 corresponding to the instructions of FIGS. 7 and/or 9 may be stored in the mass storage device 1328, in the volatile memory 1314, in the non-volatile memory 1316, in the local memory 1313 and/or on a removable tangible computer readable storage medium, such as a CD or DVD 1336.

FIG. 14 is a block diagram of an example processor platform 1400 structured to execute the instructions of FIGS. 7 and/or 10 to implement the example media device 500 of FIGS. 1, 2 and/or 5. The processor platform 1400 can be, for example, a server, a personal computer, a mobile device (e.g., a cell phone, a smart phone, a tablet such as an iPad™), a PDA, an Internet appliance, a DVD player, a CD player, a digital video recorder, a Blu-ray player, a gaming console, a personal video recorder, a set top box, a digital camera, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors or controllers from any desired family or manufacturer. In the illustrated example of FIG. 14, the processor 1412 includes one or more example processing cores 1415 configured via example instructions 1432 to implement the example media device 500, the example device meter 505, the example media stream receiver 515, the example media player 520, the example media identifier detector 525 and/or the example monitoring data reporter 530 of FIGS. 1, 2 and/or 5.

The processor 1412 of the illustrated example includes a local memory 1413 (e.g., a cache). The processor 1412 of the illustrated example is in communication with a main memory including a volatile memory 1414 and a non-volatile memory 1416 via a link 1418. The link 1418 may be implemented by a bus, one or more point-to-point connections, etc., or a combination thereof. The volatile memory 1414 may be implemented by SDRAM, DRAM, RDRAM and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes the example clock 540 of FIG. 5. The clock 540 is in communication with the processor 1412 via the link 1418.

The processor platform 1400 of the illustrated example also includes an interface circuit 1420. The interface circuit 1420 may be implemented by any type of interface standard, such as an Ethernet interface, a USB, and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1400, can allow the user to control the computer system and provide data to the computer using physical gestures, such as, but not limited to, hand or body movements, facial expressions, and face recognition.

One or more output devices 1424 are also connected to the interface circuit 1420 of the illustrated example. The output devices 1424 can be implemented, for example, by display devices (e.g., an LED, an OLED, a liquid crystal display, a CRT, a touchscreen, a tactile output device, a printer and/or speakers). The interface circuit 1420 of the illustrated example, thus, typically includes a graphics driver card, a graphics driver chip or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a DSL, a telephone line, coaxial cable, a cellular telephone system, etc.). In the illustrated example of FIG. 14, the interface circuit is also structured to implement the example network I/F 510 of the media device 500.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and DVD drives.

Coded instructions 1432 corresponding to the instructions of FIGS. 7 and/or 10 may be stored in the mass storage device 1428, in the volatile memory 1414, in the non-volatile memory 1416, in the local memory 1413 and/or on a removable tangible computer readable storage medium, such as a CD or DVD 1436.

FIG. 15 is a block diagram of an example processor platform 1500 structured to execute the instructions of FIGS. 7 and/or 11 to implement the example service provider server 125 of FIGS. 1, 2 and/or 6. The processor platform 1500 can be, for example, a server, a personal computer, a mobile device (e.g., a cell phone, a smart phone, a tablet such as an iPad™), a PDA, an Internet appliance, a DVD player, a CD player, a digital video recorder, a Blu-ray player, a gaming console, a personal video recorder, a set top box, or any other type of computing device.

The processor platform 1500 of the illustrated example includes a processor 1512. The processor 1512 of the illustrated example is hardware. For example, the processor 1512 can be implemented by one or more integrated circuits, logic circuits, microprocessors or controllers from any desired family or manufacturer. In the illustrated example of FIG. 15, the processor 1512 includes one or more example processing cores 1515 configured via example instructions 1532 to implement the example service provider server 125, the example monitoring data receiver 615, the example device identifier decoder 620 and/or the example data reporter 625 of FIGS. 1, 2 and/or 6.

The processor 1512 of the illustrated example includes a local memory 1513 (e.g., a cache). The processor 1512 of the illustrated example is in communication with a main memory including a volatile memory 1514 and a non-volatile memory 1516 via a link 1518. The link 1518 may be implemented by a bus, one or more point-to-point connections, etc., or a combination thereof. The volatile memory 1514 may be implemented by SDRAM, DRAM, RDRAM and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a USB, and/or a PCI express interface.

In the illustrated example, one or more input devices 1522 are connected to the interface circuit 1520. The input device(s) 1522 permit(s) a user to enter data and commands into the processor 1512. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1500, can allow the user to control the computer system and provide data to the computer using physical gestures, such as, but not limited to, hand or body movements, facial expressions, and face recognition.

One or more output devices 1524 are also connected to the interface circuit 1520 of the illustrated example. The output devices 1524 can be implemented, for example, by display devices (e.g., an LED, an OLED, a liquid crystal display, a CRT, a touchscreen, a tactile output device, a printer and/or speakers). The interface circuit 1520 of the illustrated example, thus, typically includes a graphics driver card, a graphics driver chip or a graphics driver processor.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a DSL, a telephone line, coaxial cable, a cellular telephone system, etc.). In the illustrated example of FIG. 15, the interface circuit is also structured to implement the example network I/F 605 of the service provider server 125.

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, RAID systems, and DVD drives. In some examples, the mass storage device 1528 may implement the example demographics data storage 610. Additionally or alternatively, in some examples the volatile memory 1514 may implement the example demographics data storage 610.

Coded instructions 1532 corresponding to the instructions of FIGS. 7 and/or 11 may be stored in the mass storage device 1528, in the volatile memory 1514, in the non-volatile memory 1516, in the local memory 1513 and/or on a removable tangible computer readable storage medium, such as a CD or DVD 1536.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method to perform audience measurement, the method comprising:
performing, with a processor, a hashing operation on a first media identifier and a plurality of data values to determine a plurality of hashed media identifiers to identify first media, a first one of the hashed media identifiers being different from a second one of the hashed media identifiers;
sending, with the processor, the first one of the hashed media identifiers to a media provider to identify the first media during a first monitoring interval; and
determining, with the processor, first audience measurement data associated with the first media and the first monitoring interval based on first reporting data received from a service provider different from the media provider, the first reporting data including the first one of the hashed media identifiers and demographic data corresponding to a subscriber associated with a media device that received the first media from the media provider.

2. A method as defined in claim 1, wherein respective ones of the hashed media identifiers are associated with respective different monitoring intervals, and further comprising sending the respective ones of the hashed media identifiers to the media provider to identify the first media during the respective different monitoring intervals.

3. A method as defined in claim 2, wherein performing the hashing operation comprises:
performing the hashing operation on the first media identifier and a first one of the data values to determine the first one of the hashed media identifiers associated with the first monitoring interval; and
performing the hashing operation on the first media identifier and a second one of the data values to determine a second one of the hashed media identifiers associated with a second monitoring interval.

4. A method as defined in claim 2, wherein the plurality of data values includes respective temporal values associated with respective ones of the different monitoring intervals.

5. (canceled)

6. (canceled)

7. A method as defined in claim 1, wherein determining the first audience measurement data comprises:
accessing a first server using the first one of the hashed media identifiers to determine first descriptive data associated with the first media, the first server cross-referencing the first one of the hashed media identifiers with at least one of the first descriptive data or the first media identifier; and
combining the first descriptive data with the demographic data to determine the first audience measurement data.

8. (canceled)

9. A method as defined in claim 7, wherein the first server cross-references pluralities of the hashed media identifiers identifying a plurality of different media with a plurality of descriptive data associated with the plurality of different media, respective pluralities of the hashed media identifiers identifying respective ones of the different media.

10. A method as defined in claim 1, wherein using the first one of the hashed media identifiers to determine the audience measurement data associated with the first media preserves privacy of a user of the media device by permitting the service provider to relay the first one of the hashed media identifiers from the media device to an audience measurement entity without the service provider being able to identify the first media.

11. A tangible machine readable storage medium comprising machine readable instructions which, when executed, cause a machine to at least:
perform a hashing operation on a first media identifier and a plurality of data values to determine a plurality of hashed media identifiers to identify first media, a first one of the hashed media identifiers being different from a second one of the hashed media identifiers;
send the first one of the hashed media identifiers to a media provider to identify the first media during a first monitoring interval; and
determine first audience measurement data associated with the first media and the first monitoring interval based on first reporting data received from a service provider different from the media provider, the first reporting data including the first one of the hashed media identifiers and demographic data corresponding to a subscriber associated with a media device that received the first media from the media provider.

12. A storage medium as defined in claim 11, wherein respective ones of the hashed media identifiers are associated with respective different monitoring intervals, and the machine readable instructions, when executed, further cause the machine to send the respective ones of the hashed media identifiers to the media provider to identify the first media during the respective different monitoring intervals.

13. A storage medium as defined in claim 12, wherein to perform the hashing operation, the machine readable instructions, when executed, further cause the machine to:
perform the hashing operation on the first media identifier and a first one of the data values to determine the first one of the hashed media identifiers associated with the first monitoring interval; and
perform the hashing operation on the first media identifier and a second one of the data values to determine a second one of the hashed media identifiers associated with a second monitoring interval.

14. A storage medium as defined in claim 12, wherein the plurality of data values includes respective temporal values associated with respective ones of the different monitoring intervals.

15. (canceled)

16. (canceled)

17. A storage medium as defined in claim 11, wherein to determine the first audience measurement data, the machine readable instructions, when executed, further cause the machine to:
access a first server using the first one of the hashed media identifiers to determine first descriptive data associated with the first media, the first server cross-referencing the first one of the hashed media identifiers with at least one of the first descriptive data or the first media identifier; and
combine the first descriptive data with the demographic data to determine the first audience measurement data.

18. (canceled)

19. A storage medium as defined in claim 17, wherein the first server cross-references pluralities of the hashed media identifiers identifying a plurality of different media with a plurality of descriptive data associated with the plurality of different media, respective pluralities of the hashed media identifiers identifying respective ones of the different media.

20. A storage medium as defined in claim 11, wherein using the first one of the hashed media identifiers to determine the audience measurement data associated with the first media preserves privacy of a user of the media device by permitting the service provider to relay the first one of the hashed media identifiers from the media device to an audience measurement entity without the service provider being able to identify the first media.

21. A server to perform audience measurement, the server comprising:
a hashed identifier generator to perform a hashing operation on a first media identifier and a plurality of data values to determine a plurality of hashed media identifiers to identify first media, a first one of the hashed media identifiers being different from a second one of the hashed media identifiers;
a hashed identifier sender to send the first one of the hashed media identifiers to a media provider to identify the first media during a first monitoring interval; and
an audience measurement data determiner to determine first audience measurement data associated with the first media and the first monitoring interval based on first reporting data received from a service provider different from the media provider, the first reporting data including the first one of the hashed media identifiers and demographic data corresponding to a subscriber associated with a media device that received the first media from the media provider.

22. A server as defined in claim 21, wherein respective ones of the hashed media identifiers are associated with respective different monitoring intervals, and the hashed identifier sender is further to send the respective ones of the hashed media identifiers to the media provider to identify the first media during the respective different monitoring intervals.

23. A server as defined in claim 22, wherein the hashed identifier generator is further to:
perform the hashing operation on the first media identifier and a first one of the data values to determine the first one of the hashed media identifiers associated with the first monitoring interval; and
perform the hashing operation on the first media identifier and a second one of the data values to determine a second one of the hashed media identifiers associated with a second monitoring interval.

24. A server as defined in claim 22, wherein the plurality of data values includes respective temporal values associated with respective ones of the different monitoring intervals.

25. (canceled)

26. (canceled)

27. A server as defined in claim 21, wherein the audience measurement data determiner is further to:
access a first server using the first one of the hashed media identifiers to determine first descriptive data associated with the first media, the first server cross-referencing the first one of the hashed media identifiers with at least one of the first descriptive data or the first media identifier; and
combine the first descriptive data with the demographic data to determine the first audience measurement data.

28. (canceled)

29. A server as defined in claim 27, wherein the first server cross-references pluralities of the hashed media identifiers identifying a plurality of different media with a plurality of descriptive data associated with the plurality of different media, respective pluralities of the hashed media identifiers identifying respective ones of the different media.

30. A server as defined in claim 21, wherein using the first one of the hashed media identifiers to determine the audience measurement data associated with the first media preserves privacy of a user of the media device by permitting the service provider to relay the first one of the hashed media identifiers from the media device to an audience measurement entity without the service provider being able to identify the first media.

31-66. (canceled)
